(19) United States
(12) Patent Application Publication
(10) Pub. No.: US 2025/0039885 A1
(43) Pub. Date: Jan. 30, 2025

(54) COMMUNICATION METHOD AND APPARATUS, DEVICE, STORAGE MEDIUM, CHIP, PRODUCT, AND PROGRAM

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 18/919,210

(22) Filed: Oct. 17, 2024

Related U.S. Application Data
(63) Continuation of application No. PCT/CN2022/089040, filed on Apr. 25, 2022.

(51) Int. Cl. H04W 72/21; H04W 76/28

(52) U.S. Cl. CPC H04W 72/21; H04W 76/28

(57) ABSTRACT

Embodiments of this application provide a communication method and apparatus, a device, a storage medium, a chip, a product, and a program. The method includes: determining, by a terminal device, a first uplink resource, where the first uplink resource is used to transmit first information; and transmitting, by the terminal device, the first information on the first uplink resource, or skipping, by the terminal device, transmitting the first information on the first uplink resource.

### CROSS-REFERENCE TO RELATED APPLICATIONS

This application is a continuation of International Application No. PCT/CN2022/089040, filed on Apr. 25, 2022, the disclosure of which is hereby incorporated by reference in its entirety.

### TECHNICAL FIELD

Embodiments of this application relate to the field of mobile communications technologies, and in particular, to a communication method and apparatus, a device, a storage medium, a chip, a product, and a program.

### BACKGROUND

In a communications system, how a terminal device sends uplink information is always a concern in the art.

### SUMMARY

Embodiments of this application provide a communication method and apparatus, a device, a storage medium, a chip, a product, and a program.

According to a first aspect, an embodiment of this application provides a communication method. The method includes:
determining, by a terminal device, a first uplink resource, where the first uplink resource is used to transmit first information; and
transmitting, by the terminal device, the first information on the first uplink resource, or skipping, by the terminal device, transmitting the first information on the first uplink resource.

According to a second aspect, an embodiment of this application provides a communication method. The method includes:
determining, by a network device, a first uplink resource, where the first uplink resource is used to transmit first information; and
detecting, by the network device, the first information on the first uplink resource.

According to a third aspect, an embodiment of this application provides a communications apparatus. The communications apparatus includes:
a determining unit, configured to determine a first uplink resource, where the first uplink resource is used to transmit first information; and
a transmission unit, configured to transmit the first information on the first uplink resource, or skip transmitting the first information on the first uplink resource.

According to a fourth aspect, an embodiment of this application provides a communications apparatus. The communications apparatus includes:
a determining unit, configured to determine a first uplink resource, where the first uplink resource is used to transmit first information; and
a detection unit, configured to detect the first information on the first uplink resource.

According to a fifth aspect, an embodiment of this application provides a terminal device. The terminal device includes a processor and a memory, where
the memory stores a computer program that can be run on the processor; and
when executing the program, the processor implements the method according to the first aspect.

According to a sixth aspect, an embodiment of this application provides a network device. The network device includes a processor and a memory, where
the memory stores a computer program that can be run on the processor; and
when executing the program, the processor implement the method according to the second aspect.

According to a seventh aspect, an embodiment of this application provides a computer storage medium. The computer storage medium stores one or more programs, and the one or more programs may be executed by one or more processors to implement the method according to the first aspect or the second aspect.

According to an eighth aspect, an embodiment of this application provides a chip, including: a processor, configured to invoke and run a computer program in a memory to execute the method according to the first aspect or the second aspect.

According to a ninth aspect, an embodiment of this application provides a computer program product. The computer program product includes a computer storage medium, the computer storage medium stores a computer program, the computer program includes instructions that can be executed by at least one processor, and the instructions, when executed by the at least one processor, implement the method according to the first aspect or the second aspect.

According to a tenth aspect, a computer program is provided. The computer program causes a computer to execute the method according to the first aspect or the second aspect.

In embodiments of this application, a terminal device determines a first uplink resource, where the first uplink resource is used to transmit first information; and the terminal device transmits the first information on the first uplink resource, or the terminal device does not transmit the first information on the first uplink resource.

### BRIEF DESCRIPTION OF DRAWINGS

The accompanying drawings described herein are used to provide a further understanding of this application, and constitute a part of this application. A schematic embodiment of this application and descriptions thereof are used to explain this application, and do not impose an improper limitation on this application. In the accompanying drawings:

FIG. 1 is a schematic diagram of an application scenario according to an embodiment of this application.

FIG. 2 is a schematic diagram of a architecture of a communications system according to an embodiment of this application.

FIG. 3 is a schematic diagram of a architecture of another communications system according to an embodiment of this application.

FIG. 4 is a schematic diagram of detecting an uplink resource by a network device according to a related technology.

FIG. 5 is a schematic flowchart of a communication method according to an embodiment of this application.

FIG. 6 is a schematic flowchart of another communication method according to an embodiment of this application.

FIG. 7 is a schematic flowchart of still another communication method according to an embodiment of this application.

FIG. 8a is a schematic diagram of a manner of reporting first information by a terminal device according to an embodiment of this application.

FIG. 8b is a schematic diagram of another manner of reporting first information by a terminal device according to an embodiment of this application.

FIG. 8c is a schematic diagram of still another manner of reporting first information by a terminal device according to an embodiment of this application.

FIG. 9 is a schematic diagram of reporting first information by a terminal device by using an SR resource according to an embodiment of this application.

FIG. 10 is a schematic diagram of a structural composition of a communications apparatus according to an embodiment of this application, which is applied to a terminal device.

FIG. 11 is a schematic diagram of a structural composition of another communications apparatus according to an embodiment of this application.

FIG. 12 is a schematic structural diagram of a communications device according to an embodiment of this application.

FIG. 13 is a schematic structural diagram of a chip according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. All other embodiments obtained by persons of ordinary skill in the art based on embodiments of this application without creative efforts fall within the protection scope of this application.

The technical solutions described in embodiments of this application may be randomly combined without a conflict. In the descriptions of this application, “a plurality of” means two or more, unless otherwise specifically limited.

Scenarios of a communications system include a terrestrial network (TN) and a non-terrestrial network (NTN). The NTN may provide a communication service for a terrestrial user through satellite communication. The NTN system may include a new radio (NR)-NTN and an internet of things (IoT)-NTN system.

FIG. 1 is a schematic diagram of an application scenario according to an embodiment of this application. As shown in FIG. 1, a communications system 100 may be a terrestrial communications network system. The communications system 100 may include a terminal device 110 and a network device 120. The network device 120 may communicate with the terminal device 110 through an air interface. Multi-service transmission is supported between the terminal device 110 and the network device 120.

It should be understood that the communications system 100 is merely used as an example for illustration of embodiments of this application, but the embodiments of this application are not limited thereto. That is, the technical solutions in embodiments of this application may be applied to various communications systems, for example, a long term evolution (LTE) system, an LTE time division duplex (TDD) system, a universal mobile telecommunication system (UMTS), an internet of things (IoT) system, a narrow band internet of things (NB-IoT) system, an enhanced machine-type communications (eMTC) system, a 5G communications system (also referred to as a new radio communications system), or a future communications system (for example, a 6G or 7G communications system).

The network device 120 in this embodiment of this application may include an access network device 121 and/or a core network device 122. The access network device may provide communication coverage for a specific geographical area, and may communicate with the terminal device 110 (for example, UE) located in the coverage.

The terminal device in this application may be referred to as user equipment (UE), a mobile station (MS), a mobile terminal (MT), a subscriber unit, a subscriber station, a mobile station, a remote station, a remote terminal, a mobile device, a user terminal, a terminal, a wireless communications device, a user agent, or a user apparatus. The terminal device may include one or a combination of at least two of the following: an internet of things (IoT) device, a satellite terminal, a wireless local loop (WLL) station, a personal digital assistant (PDA), a handheld device with a wireless communication function, a computing device, another processing device connected to a wireless modem, a server, a mobile phone, a tablet computer (Pad), a computer with a wireless transceiver function, a palmtop computer, a desktop computer, a personal digital assistant, a portable media player, a smart speaker, a navigation apparatus, a wearable device such as a smart watch, smart glasses, or a smart necklace, a pedometer, a digital TV, a virtual reality (VR) terminal device, an augmented reality (AR) terminal device, a wireless terminal in industrial control, a wireless terminal in self-driving, a wireless terminal in a remote medical surgery, a wireless terminal in a smart grid, a wireless terminal in transportation safety, a wireless terminal in smart city, a wireless terminal in smart home, a vehicle in an internet of vehicles system, a vehicle-mounted device, a vehicle-mounted module, a wireless modem, a handheld device, customer premise equipment (CPE), or a smart appliance.

Optionally, the terminal device 110 may be any terminal device, and includes but is not limited to a terminal device that is connected to the network device 120 or another terminal device through a wired or wireless connection.

Optionally, the terminal device 110 may be used for device to device (D2D) communication.

The access network device 121 may include one of or a combination of at least two of the following: an evolved NodeB (eNB or eNodeB) in a Long Term Evolution (LTE) system, a next generation radio access network (NG RAN) device, a gNB in an NR system, a small cell, a micro base station, a radio controller in a cloud radio access network (CRAN), an access point in wireless fidelity (Wi-Fi), a transmission reception point (TRP), a relay station, an access point, a vehicle-mounted device, a wearable device, a concentrator, a switch, a bridge, a router, or a network device in a future evolved public land mobile network (PLMN).

The core network device 122 may be a 5G core (5GC) device, and the core network device 122 may include one of or a combination of at least two of the following: an access and mobility management function (AMF), an authentication server function (AUSF), a user plane function (UPF), a session management function (SMF), or a location management function (LMF). In some other implementations, the core network device may also be an evolved packet core (EPC) device of an LTE network, for example, a session management function+core packet gateway (SMF+PGW-C) device. It should be understood that the SMF+PGW-C may implement both a function that can be implemented by an SMF and a function that can be implemented by a PGW-C. In a network evolution process, the core network device 122 may also be called another name, or a new network entity may be formed by dividing a function of the core network, which is not limited in embodiments of this application.

Communication between function units in the communications system 100 may also be implemented by establishing a connection with the use of a next generation (NG) interface.

For example, the terminal device establishes an air interface connection to an access network device by using an NR interface, to transmit user plane data and control plane signalling. The terminal device may establish a control plane signalling connection to an AMF by using an NG interface 1 (N1 for short). The access network device, for example, a next-generation radio access base station (gNB), may establish a user plane data connection to a UPF by using an NG interface 3 (N3 for short). The access network device may establish a control plane signalling connection to the AMF by using an NG interface 2 (N2 for short). The UPF may establish a control plane signalling connection to an SMF by using an NG interface 4 (N4 for short). The UPF may exchange user plane data with a data network by using an NG interface 6 (N6 for short). The AMF may establish a control plane signalling connection to the SMF by using an NG interface 11 (N11 for short). The SMF may establish a control plane signalling connection to a PCF by using an NG interface 7 (N7 for short).

FIG. 1 exemplarily shows one base station, one core network device, and two terminal devices. Optionally, the wireless communications system 100 may include a plurality of base station devices, and another quantity of terminal devices may be included within coverage of each base station. This is not limited in embodiments of this application.

3GPP further studies a non-terrestrial network (NTN) technology. The NTN generally provides a communication service for a terrestrial user through satellite communication. Compared with terrestrial cellular network communication, satellite communication has many unique advantages. First, satellite communication is not limited by a user location. For example, general terrestrial communication cannot cover areas such as a sea, a mountain, and a desert in which a communications device cannot be set up or no communication coverage is implemented due to sparse population. However, in satellite communication, since one satellite may cover a relatively large terrestrial area, and further, a satellite may orbit the earth, every corner of the earth may be covered theoretically by satellite communication. Second, satellite communication has a great social value. Satellite communication may cover remote mountains or poor and backward countries or regions at low costs. This enables people in these regions to enjoy advanced voice communication and mobile Internet technologies, which helps narrow a digital divide with developed regions and promote development of these regions. Third, a communication distance of satellite communication is long, and communication costs are not significantly increased with an increase of the communication distance. Finally, satellite communication has high stability and is not limited by a natural condition.

The NTN technology may be combined with various communications systems. For example, the NTN technology may be combined with the NR system into an NR-NTN system. For another example, the NTN technology may be combined with the internet of things (IoT) system into an IoT-NTN system. For example, the IoT-NTN system may include an NB-IoT-NTN system and an eMTC-NTN system.

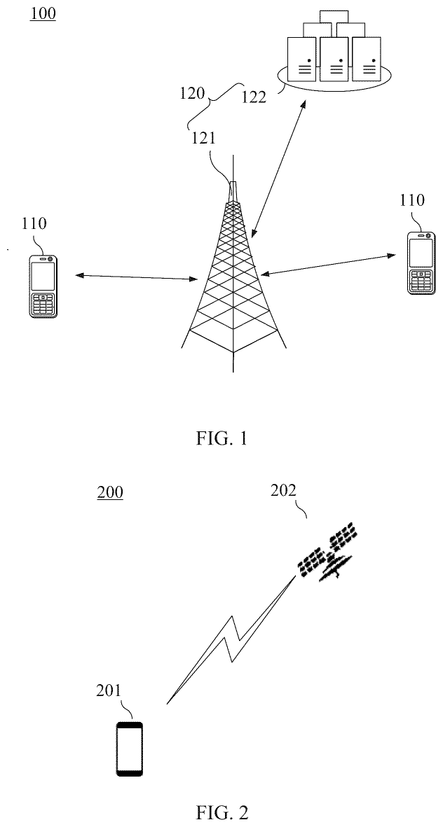

FIG. 2 is a schematic diagram of an architecture of a communications system according to an embodiment of this application. As shown in FIG. 2, a communications system 200 in FIG. 2 may be a non-terrestrial communications network system. The communications system 200 includes a terminal device 201 and a satellite 202, and wireless communication may be performed between the terminal device 201 and the satellite 202. A network formed between the terminal device 201 and the satellite 202 may also be referred to as an NTN. In the architecture of the communications system 200 shown in FIG. 2, the satellite 202 may have a function of a base station, and the terminal device 201 and the satellite 202 may directly communicate with each other. In this system architecture, the satellite 202 may be referred to as a network device. In some embodiments of this application, the communications system 200 may include a plurality of network devices 202, and another quantity of terminal devices may be included within coverage of each network device 202. This is not limited in embodiments of this application.

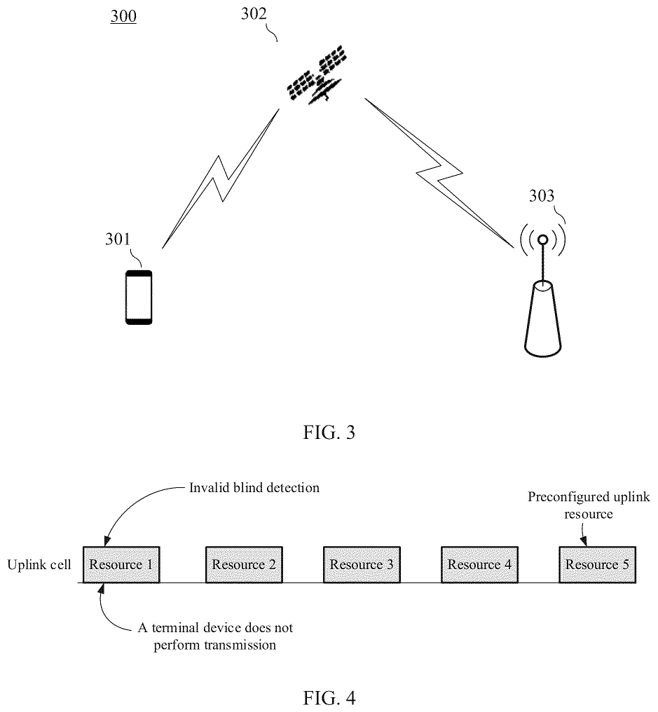

FIG. 3 is a schematic diagram of an architecture of another communications system according to an embodiment of this application. As shown in FIG. 3, a communications system 300 in FIG. 3 may be a non-terrestrial communications network system. The communications system 300 includes a terminal device 301, a satellite 302, and a base station 303, wireless communication may be performed between the terminal device 301 and the satellite 302, and the satellite 302 and the base station 303 may communicate with each other. A network formed among the terminal device 301, the satellite 302, and the base station 303 may also be referred to as an NTN. In the architecture of the communications system 300 shown in FIG. 3, the satellite 302 may not have a function of a base station, and communication between the terminal device 301 and the base station 303 needs to be forwarded by using the satellite 302. In this system architecture, the base station 303 may be referred to as a network device. In some embodiments of this application, the communications system 300 may include a plurality of network devices 303, and another quantity of terminal devices may be included within coverage of each network device 303. This is not limited in embodiments of this application. The network device 303 may be the network device 120 in FIG. 1.

It should be understood that the satellite 202 or the satellite 302 includes but is not limited to: a low-earth orbit (LEO) satellite, a medium-earth orbit (MEO) satellite, a geostationary earth orbit (GEO) satellite, a high elliptical orbit (HEO) satellite, and the like. The satellite may use a plurality of beams to cover the ground. For example, one satellite may form dozens or even hundreds of beams to cover the ground. In other words, one satellite beam may cover a terrestrial area of tens to hundreds of kilometers in diameter, to ensure coverage of a satellite and improve a system capacity of the entire satellite communications system.

For example, a height range of the LEO satellite may be 500 km to 1500 km, and a corresponding orbital period may be about 1.5 hours to 2 hours. A signal propagation delay of single-hop communication between users may be generally less than 20 ms. A maximum satellite visible time may be 20 minutes. A signal propagation distance of the LEO satellite is short, a link loss is small, and a transmit power requirement for a user terminal is not high. An orbit height of the GEO satellite may be 35,786 km, a rotation period around the earth may be 24 hours, and a signal propagation delay of single-hop communication between users may be generally 250 milliseconds.

To ensure coverage of a satellite and improve a system capacity of the entire satellite communications system, the satellite uses a plurality of beams to cover the ground. One satellite may form dozens or even hundreds of beams to cover the ground, and one satellite beam may cover a terrestrial area of tens to hundreds of kilometers in diameter.

It should be noted that FIG. 1 to FIG. 3 are merely examples of systems to which this application is applicable. Certainly, the method shown in embodiments of this application may be further applicable to another system. In addition, the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects. It should also be understood that, the “indication” mentioned in embodiments of this application may be a direct indication or an indirect indication, or indicate an association relationship. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association relationship between A and B. It should be further understood that the term “corresponding” mentioned in embodiments of this application may mean that there is a direct or indirect correspondence between two elements, or that there is an association relationship between two elements, or that there is a relationship of “indicating” and “being indicated”, “configuring” and “being configured”, or the like. It should be further understood that the “predefining”, “protocol agreement”, “predetermining” or “predefined rule” mentioned in embodiments of this application may be implemented in a manner in which corresponding code, a table, or other related information used for indication is prestored in a device (for example, including a terminal device and a network device). A specific implementation is not limited in this application. For example, the “predefining” may refer to being defined in a protocol. It should be further understood that in embodiments of this application, the “protocol” may refer to a standard protocol in the communications field, for example, may include an LTE protocol, an NR protocol, and a related protocol applied to a future communications system. This is not limited in this application.

The satellite may be classified into a transparent payload satellite and a regenerative payload satellite in terms of provided functions. The transparent payload satellite may provide radio frequency filtering, frequency conversion, and amplification, and may provide transparent forwarding of signals, and does not change waveform signals forwarded by the satellite. In addition to radio frequency filtering, frequency conversion, and amplification, the regenerative payload satellite may provide demodulation/decoding, routing/conversion, and coding/modulation functions, and has some or all functions of a base station.

To facilitate understanding of the technical solutions in embodiments of this application, the following describes related technologies in embodiments of this application. The following related technologies, as optional solutions, may be arbitrarily combined with the technical solutions in embodiments of this application, which are all within the protection scope of embodiments of this application.

Network energy saving is significant for environmental sustainability, reducing environmental impact (reducing greenhouse gas emissions), and saving an operational expenditure. As 5G is gradually popularized in various industrial and geographical regions, a very high data transmission rate needs to be supported to process more advanced services and applications, for example, extended reality (XR), and network deployment becomes denser, and more antennas, larger bandwidth, and more bands are used. Considering the environmental impact of 5G, it is necessary to develop a controlled and new solution to enhance network energy saving.

Energy consumption has become a key part of an operational expenditure (OPEX) of an operator. An energy expenditure of a mobile network accounts for approximately 23% of a total operational expenditure. Most of the energy consumption comes from a radio access network, and more specifically, from an active antenna unit (AAU), where a data center and fiber transmission account for a smaller share. Power consumption of a single radio access may be divided into two parts: a dynamic part, including power consumption when data is being sent or received; and a static part, including power consumption to maintain necessary operations of a radio access device at all times, and including power consumption when data is not sent or received.

An implementation of network energy saving in a related technology is as follows: When a network device is in an idle state, a transmission period of a synchronization signal block (SSB) and a system information block (SIB) may be increased. The SIB may include at least one SIB, and the at least one SIB may include, for example, at least one of an SIB 1, an SIB 2, an SIB 3, or the like. However, in this method, a delay of initial access of a terminal device may increase. For the terminal device, this may therefore result in that the terminal device fails to identify the cell in a relatively long SSB transmission period, and cannot thus access a network.

In a related technology, it is proposed that a terminal device may send, to a network device, some auxiliary information for assisting the network device in determining whether to carry out a network energy saving technology. However, there is no specific solution to how to send the auxiliary information by the terminal device and how to determine, by the network device based on the auxiliary information sent by the terminal device, whether to employ the network energy saving technology.

In a related technology, to cope with a possible burst uplink service of the terminal device, the network device may configure a periodic or aperiodic uplink resource (aperiodic, for example, active semi-static configuration) for the terminal device, for example, a physical uplink control channel (PUCCH) resource, or a configured grant-physical uplink shared channel (CG-PUSCH) resource. When an uplink service arrives, the terminal device may send a scheduling request SR to the network device by using the PUCCH resource, to request a physical uplink shared channel (PUSCH) resource used for transmitting the uplink service, or transmit the uplink service to the network device by using the CG-PUSCH resource.

FIG. 4 is a schematic diagram of detecting an uplink resource by a network device according to a related technology. As shown in FIG. 4, for an uplink cell (which may be understood as an uplink transmission or an uplink carrier), a network device may preconfigure an uplink resource. As shown in a shaded part in FIG. 4, the uplink resource includes a resource 1, a resource 2, a resource 3, a resource 4, and a resource 5. The network device may sequentially perform blind detection on the resource 1, the resource 2, the resource 3, the resource 4, and the resource 5, to obtain information sent by a terminal device. However, the terminal device does not perform transmission on the resource 1, but the network device still performs blind detection on the resource 1, and consequently the network device performs invalid blind detection on the resource 1.

The preconfigured uplink resource may be periodic or aperiodic. In some scenarios of a related technology, the network device may configure preconfigured uplink resources for the terminal device. Therefore, regardless of whether the terminal device performs transmission on these preconfigured uplink resources, the network device needs to perform blind detection on these resources, and consequently the network device may perform a large amount of invalid blind detection, thereby consuming unnecessary power.

In another related technology, if the network device does not preconfigure an uplink resource for the terminal device, this may result in that the terminal device cannot interact with the network device when an uplink service arrives, or can only request an uplink resource from the network device by using a physical random access channel (PRACH), thereby causing an excessive uplink transmission delay.

To facilitate understanding of the technical solutions in embodiments of this application, the following describes the technical solutions in this application in detail by using specific embodiments. The foregoing related technologies, as optional solutions, may be arbitrarily combined with the technical solutions of embodiments of this application, all of which fall within the protection scope of embodiments of this application. Embodiments of this application include at least a part of the following content.

It should be understood that, in some embodiments of this application, a cell and a carrier may be equivalent. For example, a “downlink cell” may be replaced with a “downlink carrier”, and an “uplink cell” may be replaced with an “uplink carrier”, and so on.

In some embodiments of this application, the terminal device may predict a situation of an uplink service of the terminal device, for example, when the uplink service arrives, a data amount of the uplink service, or when the uplink service does not exist. Therefore, the terminal device may notify the network device of some auxiliary information such as the situation of the uplink service of the terminal device, so that the network device can properly configure or deconfigure these preconfigured uplink resources for the terminal device based on the auxiliary information reported by the terminal device.

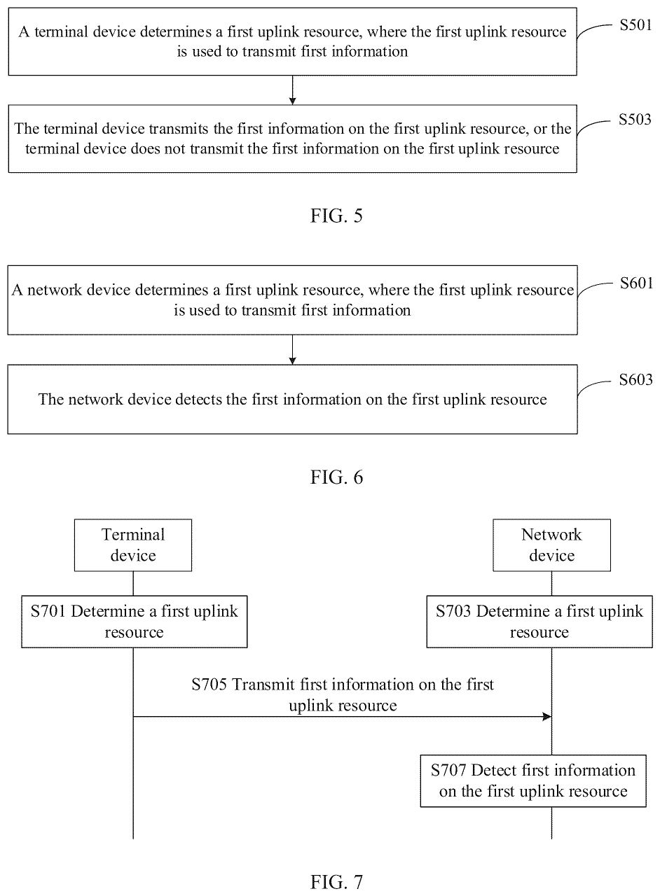

FIG. 5 is a schematic flowchart of a communication method according to an embodiment of this application. As shown in FIG. 5, the method includes the following steps.

S501: A terminal device determines a first uplink resource, where the first uplink resource is used to transmit first information.

S503: The terminal device transmits the first information on the first uplink resource, or the terminal device does not transmit the first information on the first uplink resource.

Optionally, the first information may also be referred to as first auxiliary information in some other embodiments. Optionally, the communication method may further include: determining, by the terminal device, the first information.

In some embodiments, the first uplink resource may be used to transmit the first information, but not to transmit information other than the first information. In some other embodiments, the first uplink resource may be used to transmit the first information, and may be also used to transmit other information. Optionally, the other information may include at least one of the following: a scheduling request (SR), a hybrid automatic repeat request-acknowledgment (HARQ-ACK), or channel state information (CSI).

Optionally, in a case that the terminal device does not transmit the first information on the first uplink resource, the terminal device may transmit at least one of the following on the first uplink resource: an SR, a HARQ-ACK, CSI, or the like. Optionally, in a case that the terminal device does not transmit the first information on the first uplink resource, the terminal device may not transmit any information on the first uplink resource.

In this embodiment of this application, a terminal device determines a first uplink resource, where the first uplink resource is used to transmit first information; and the terminal device transmits the first information on the first uplink resource, or the terminal device does not transmit the first information on the first uplink resource. In this way, the terminal device can transmit the first information or does not transmit the first information on the first uplink resource used for transmitting the first information, so that the first information can be transmitted on the first uplink resource used for transmitting the first information, thereby improving transmission reliability.

In addition, in some cases, the terminal device can enable multiplexed transmission of the first information and other information on a same uplink resource, thereby improving uplink transmission efficiency.

FIG. 6 is a schematic flowchart of another communication method according to an embodiment of this application. As shown in FIG. 6, the method includes the following steps.

S601: A network device determines a first uplink resource, where the first uplink resource is used to transmit first information.

S603: The network device detects the first information on the first uplink resource.

Optionally, in a case that the network device determines the first uplink resource, the network device may detect information on the first uplink resource to detect the first information. Optionally, because the network device cannot determine whether the first information transmitted by a terminal device exists on the first uplink resource, the network device always needs to perform detection on the first uplink resource to detect the first information.

In some embodiments, the network device can detect the first information on the first uplink resource. In some other embodiments, the network device cannot detect the first information on the first uplink resource.

Optionally, detection may also be referred to as monitoring or receiving in some other embodiments.

FIG. 7 is a schematic flowchart of still another communication method according to an embodiment of this application. As shown in FIG. 7, the method includes the following steps.

S701: A terminal device determines a first uplink resource, where the first uplink resource is used to transmit first information.

S703: A network device determines a first uplink resource, where the first uplink resource is used to transmit first information.

S705: The terminal device transmits the first information on the first uplink resource.

S707: The network device detects the first information on the first uplink resource.

In some other embodiments, S705 may be replaced with that the terminal device does not transmit the first information on the first uplink resource. Correspondingly, S707 may be replaced with that the network device does not detect the first information on the first uplink resource.

Optionally, the first uplink resource may be a periodic uplink resource or an aperiodic uplink resource. Optionally, the first uplink resource may be determined by the network device and/or the terminal device based on preconfiguration information, or the first uplink resource may be determined by the terminal device and configured for the network device, or the first uplink resource may be determined by the network device and configured for the terminal device.

Optionally, the terminal device may send the first information at intervals of a first period, or the terminal device may trigger sending of the first information based on preconfiguration information, or the network device may trigger the terminal device to send the first information.

In some embodiments, the first information may be used to determine a second uplink resource and/or a first downlink resource, or the first information may be used to indicate a second uplink resource and/or a first downlink resource.

Optionally, the second uplink resource may be a part or all of resources in a preconfigured uplink resource. Optionally, the first downlink resource may be a part or all of resources in a preconfigured downlink resource.

In some embodiments, the second uplink resource may be a resource used for sending uplink information. The terminal device may send the uplink information or not send the uplink information on the second uplink resource, and the network device performs detection on the second uplink resource to detect the uplink information.

It should be understood that the uplink information may be carried by using an uplink channel or an uplink signal.

In some other embodiments, the second uplink resource may be a resource that is not used for sending uplink information. The terminal device does not send information on the second uplink resource, and the network device does not perform detection on the second uplink resource.

In some embodiments, the first downlink resource may be a resource used for sending downlink information. The network device may send the downlink information or not send the downlink information on the first downlink resource, and the terminal device performs detection on the first downlink resource to detect the downlink information.

It should be understood that the downlink information may be carried by using a downlink channel or a downlink signal.

In some other embodiments, the first downlink resource may be a resource that is not used for transmitting downlink information. The network device does not transmit the downlink information on the first downlink resource, and the terminal device does not perform detection on the first downlink resource.

In an embodiment of this application, the first information may be used to determine the second uplink resource, or the first information may be used to indicate the second uplink resource. In a case that the second uplink resource is a resource that is not used for transmitting uplink information, the terminal device does not transmit information on the second uplink resource, and the network device does not perform detection on the second uplink resource; or in a case that the second uplink resource is a resource used for transmitting uplink information, the terminal device may transmit information on the second uplink resource, and the network device performs detection based on the second uplink resource. In this way, the network device can detect information selectively based on the second uplink resource, thereby reducing the occurrence of situations that information cannot be detected on many resources and power waste is caused because the network device needs to detect information on all preconfigured uplink resources in a related technology. Therefore, in the communication method of this application, information is detected selectively based on the second uplink resource, thereby reducing power consumption of the network device.

In an embodiment of this application, the first information may be used to determine the first downlink resource, or the first information may be used to indicate the first downlink resource. In a case that the first downlink resource is a resource that is not used for transmitting downlink information, the network device does not transmit information on the first downlink resource, and the terminal device does not perform detection on the first downlink resource; or in a case that the first downlink resource is a resource used for transmitting downlink information, the network device may transmit information on the first downlink resource, and the terminal device performs detection based on the first downlink resource. In this way, the terminal device can detect information selectively based on the first downlink resource, thereby reducing occurrence of situations that information cannot be detected on many resources and power waste is caused because the terminal device needs to detect information on all preconfigured downlink resources in a related technology. Therefore, in the communication method of this application, information is detected selectively based on the first downlink resource, thereby reducing power consumption of the terminal device.

In some embodiments, the terminal device may directly send the first information to the network device. In some other embodiments, the terminal device may send the first information to a satellite, and the satellite forwards the first information to the network device, for example, through transparent forwarding or regenerative forwarding.

Optionally, the first uplink resource and the second uplink resource are different/not coincident resources. For example, the first uplink resource and the second uplink resource may be the same in time domain and different in frequency domain. For another example, the first uplink resource and the second uplink resource may be different in time domain and same in frequency domain. For another example, the first uplink resource and the second uplink resource may be different in time domain and different in frequency domain. For another example, the first uplink resource is a PUCCH resource, and the second uplink resource is a PUSCH resource.

Optionally, in a case that a time domain of the first uplink resource is different from a time domain of the second uplink resource, the second uplink resource may be after the time domain of the first uplink resource. In some embodiments, the time domain corresponding to the first uplink resource is adjacent to the time domain corresponding to the second uplink resource. For example, an end time point corresponding to the first uplink resource and a start time point corresponding to the second uplink resource are a same time point. For another example, an end time point of a time unit corresponding to the first uplink resource and a start time point of a time unit corresponding to the second uplink resource are a same time point. In some other embodiments, the time unit corresponding to the first uplink resource and the time unit corresponding to the second uplink resource may be spaced by one or more time units. Optionally, the spaced one or more time units may be determined based on at least one of the following: processing duration of the first information, subcarrier spacing, or the like.

Optionally, in this embodiment of this application, the time unit may include one of or a combination of at least two of the following: one or more symbols, one or more slots, one or more subframes, or one or more system frames.

Optionally, the second uplink resource and/or the first downlink resource may be used to transmit control information and/or data information.

In some embodiments, the first information is used to indicate at least one of the following:
a request to deactivate a preconfigured uplink resource, a request to activate a preconfigured uplink resource, a request to deactivate a resource within a first time period in a preconfigured uplink resource, a request to activate a resource within a second time period in a preconfigured uplink resource, a request to deactivate a start time unit of a preconfigured uplink resource, a request to deactivate an end time unit of a preconfigured uplink resource, a request to deactivate a time unit length of a preconfigured uplink resource, a request to activate a start time unit of a preconfigured uplink resource, a request to activate an end time unit of a preconfigured uplink resource, a request to activate a time unit length of a preconfigured uplink resource, a cell ID associated with a preconfigured uplink resource, or an uplink service type of the terminal device;
a request to deactivate a preconfigured downlink resource, a request to activate a preconfigured downlink resource, a request to deactivate a resource within a first time period in a preconfigured downlink resource, a request to activate a resource within a second time period in a preconfigured downlink resource, a request to deactivate a start time unit of a preconfigured downlink resource, a request to deactivate an end time unit of a preconfigured downlink resource, a request to deactivate a time unit length of a preconfigured downlink resource, a request to activate a start time unit of a preconfigured downlink resource, a request to activate an end time unit of a preconfigured downlink resource, a request to activate a time unit length of a preconfigured downlink resource, a cell ID associated with a preconfigured downlink resource, or a downlink service type of the terminal device; or
a discontinuous transmission (DTX) pattern of the terminal device, a discontinuous reception (DRX) pattern of the terminal device, a transmission parameter associated with the DTX pattern, a transmission parameter associated with the DRX pattern, an uplink transmission parameter of the terminal device, a downlink transmission parameter of the terminal device, an antenna configuration of the terminal device, a power parameter of the terminal device, or a power consumption mode of the terminal device.

Optionally, the first information may indicate at least one of the foregoing information through at least one of an explicit indication, an implicit indication, a direct indication, or an indirect indication.

For example, the first information is used to indicate a request to deactivate a preconfigured uplink resource. The explicit indication may include: the first information corresponds to at least one information field, and the at least one information field is used to indicate a request to deactivate a preconfigured uplink resource. The implicit indication may include: the first information corresponds to one state (for example, the state corresponds to no transmission on the first uplink resource or corresponds to transmitting a specific sequence on the first uplink resource), and the state is used to indicate a request to deactivate a preconfigured uplink resource. Optionally, the specific sequence may be represented by one or more bits. Optionally, the specific sequence may be continuous or discontinuous or partially continuous. The direct indication may include: directly indicating, in an explicit or implicit manner, a request to deactivate a preconfigured uplink resource. The indirect indication may include: indicating other information in an explicit or implicit manner, and determining, based on the other information, a request to deactivate a preconfigured uplink resource.

Optionally, activating an uplink resource may be considered as enabling an uplink resource, or it may be considered that an activated uplink resource is a valid uplink resource, or activating an uplink resource may be considered as opening an uplink resource.

Optionally, deactivating an uplink resource may be considered as disabling an uplink resource, or it may be considered that a deactivated uplink resource is an invalid uplink resource, or deactivating an uplink resource may be considered as closing (mute) an uplink resource.

Optionally, activating a downlink resource may be considered as enabling a downlink resource, or it may be considered that an activated downlink resource is a valid downlink resource, or activating a downlink resource may be considered as opening a downlink resource.

Optionally, deactivating a downlink resource may be considered as disabling a downlink resource, or it may be considered that a deactivated downlink resource is an invalid downlink resource, or deactivating a downlink resource may be considered as closing (mute) a downlink resource.

Optionally, that the first information is used to indicate a request to activate a resource and/or a request to deactivate a resource may be understood as: the first information is used to indicate activating a resource and/or deactivating a resource.

Optionally, the preconfigured uplink resource may include a periodic uplink resource and/or an aperiodic uplink resource. Optionally, the preconfigured downlink resource may include a periodic downlink resource and/or an aperiodic downlink resource.

Optionally, the preconfigured uplink resource and/or the preconfigured downlink resource may be resources preconfigured by the network device. For example, the preconfigured uplink resource may be a PUCCH resource and/or a CG-PUSCH resource configured by using higher layer signalling. For another example, the preconfigured downlink resource may be a PDCCH resource and/or an SPS PDSCH resource configured by using higher layer signalling.

Optionally, in a case that the first information indicates activating a preconfigured resource (for example, the preconfigured resource may include at least one of the following: a preconfigured uplink resource, a preconfigured downlink resource, a resource within a second time period in a preconfigured uplink resource, a resource within a second time period in a preconfigured downlink resource, a preconfigured uplink resource of an indicated time unit length, or a preconfigured downlink resource of an indicated time unit length), a first-end device may send information or not send information by using the preconfigured resource, and a second-end device needs to perform detection on the preconfigured resource. Whether or not the second-end device may detect information on the preconfigured resource may depend on whether the first-end device sends information and/or on a channel condition. However, the second-end device needs to perform detection on the preconfigured resource, so as to prevent information missing.

Optionally, in a case that the first information indicates deactivating a preconfigured resource (for example, the preconfigured resource may include at least one of the following: a preconfigured uplink resource, a preconfigured downlink resource, a resource within a first time period in a preconfigured uplink resource, a resource within a first time period in a preconfigured downlink resource, a preconfigured uplink resource of an indicated time unit length, or a preconfigured downlink resource of an indicated time unit length), a first-end device will no longer send information through the preconfigured resource, and correspondingly, a second-end device does not need to perform detection on the preconfigured resource either. As such, if the terminal device does not need to send information or does not need to send information within a period of time, and/or does not need to receive information or does not need to receive information within a period of time, the terminal device may send the first information to the network device, so that the network device does not receive information on the deactivated preconfigured resource indicated by the first information, and/or does not send information on the deactivated preconfigured resource indicated by the first information.

Optionally, the first-end device may be the terminal device, and the second-end device may be the network device, or the first-end device may be the network device, and the second-end device may be the terminal device.

Optionally, the preconfigured resource may be alternatively a preconfigured sidelink resource. In this case, the first-end device may be a first terminal device, and the second-end device may be a second terminal device.

In some implementation scenarios, in a case that the first information indicates activating preconfigured uplink resources, each resource of the preconfigured uplink resources is a resource that can be used to transmit uplink information, and the network device needs to perform detection on each resource of the preconfigured uplink resources. In some other implementation scenarios, in a case that the first information indicates activating preconfigured downlink resources, each resource of the preconfigured downlink resources is a resource that can be used to transmit downlink information, and the terminal device needs to perform detection on each resource of the preconfigured downlink resources.

In some implementation scenarios, in a case that the first information indicates deactivating preconfigured uplink resources, each resource of the preconfigured uplink resources is an invalid resource, and the network device does not need to perform blind detection on each resource of the preconfigured uplink resources. In some other implementation scenarios, in a case that the first information indicates deactivating preconfigured downlink resources, each resource of the preconfigured downlink resources is an invalid resource, and the terminal device does not need to perform blind detection on each resource of the preconfigured downlink resources.

In some implementation scenarios, the terminal device may send, to the network device, the first information used to indicate activating a preconfigured uplink resource (for example, when the terminal device has an uplink service to be transmitted), and therefore the terminal device may send information or not send information on the subsequent preconfigured uplink resource after sending the first information, and the network device may perform detection on the subsequent preconfigured uplink resource after receiving the first information, so as to detect the information sent by the terminal device; and/or the terminal device may send, to the network device, the first information used to indicate deactivating a preconfigured uplink resource (for example, when the terminal device has no uplink service to be transmitted), and therefore the terminal device does not send information on the subsequent preconfigured uplink resource after sending the first information, and the network device may not perform detection on the subsequent preconfigured uplink resource after receiving the first information.

In some implementation scenarios, the terminal device may send, to the network device, the first information used to indicate activating a preconfigured downlink resource, and therefore the terminal device may detect information on the subsequent preconfigured downlink resource after sending the first information; and/or the terminal device may send, to the network device, the first information used to indicate deactivating a preconfigured downlink resource, and therefore the terminal device does not detect information on the subsequent preconfigured downlink resource after sending the first information.

Optionally, when the preconfigured downlink resource includes a PDCCH resource, that the terminal device detects information on the preconfigured downlink resource includes: the terminal device monitors a PDCCH on the preconfigured downlink resource; and/or that the terminal device does not detect information on the preconfigured downlink resource includes: the terminal device does not monitor a PDCCH on the preconfigured downlink resource.

Optionally, when the preconfigured downlink resource includes an SPS PDSCH resource, that the terminal device detects information on the preconfigured downlink resource includes: the terminal device receives an SPS PDSCH on the preconfigured downlink resource; and/or that the terminal device does not detect information on the preconfigured downlink resource includes: the terminal device does not receive an SPS PDSCH on the preconfigured downlink resource.

Optionally, when the preconfigured downlink resource includes an SSB resource or a channel state information-reference signal (CSI-RS) resource, that the terminal device detects information on the preconfigured downlink resource includes: the terminal device receives an SSB or a CSI-RS on the preconfigured downlink resource; and/or that the terminal device does not detect information on the preconfigured downlink resource includes: the terminal device does not receive an SSB or a CSI-RS on the preconfigured downlink resource.

Optionally, the first time period and/or the second time period may include one or more time periods. Optionally, in a case that the first time period and/or the second time period include/includes a plurality of time periods, the plurality of time periods may be continuous time periods, discontinuous time periods, or partially continuous time periods.

Optionally, the start time unit may include one of the following: a start symbol, a start slot, a start subframe, a start system frame, or the like. Optionally, the end time unit may include one of the following: an end symbol, an end slot, an end subframe, an end system frame, or the like. Optionally, the time unit length may include one of or a combination of at least two of the following: one or more symbols, one or more slots, one or more subframes, one or more system frames, or the like. Optionally, the time unit length may correspond to a certain duration.

Optionally, the cell ID associated with the preconfigured uplink resource may include: a carrier ID associated with the preconfigured uplink resource. Optionally, the cell ID associated with the preconfigured downlink resource may include a carrier ID associated with the preconfigured downlink resource. The carrier ID may include an uplink carrier ID or a downlink carrier ID. Optionally, the cell ID associated with the preconfigured uplink resource may include a physical cell identifier (PCI) associated with the preconfigured uplink resource. Optionally, the cell ID associated with the preconfigured downlink resource may include a PCI associated with the preconfigured downlink resource.

Optionally, the uplink and/or downlink service type of the terminal device may include at least one of the following: a game service, a video service, a voice call service, a video call service, a text service, or the like.

Optionally, the discontinuous transmission DTX and/or DRX pattern of the terminal device may include a DTX and/or a DRX pattern requested by the terminal device to be configured, or a DTX and/or a DRX pattern configured by the network device.

Optionally, the transmission parameter associated with the DTX pattern may include at least one of the following: a DTX cycle, a DTX enable time (dtx-onDurationTimer), a DTX deactivate time (dtx-InactivityTimer), or the like. Optionally, the transmission parameter associated with the DRX pattern may include at least one of the following: a DRX cycle, a DRX enable time (drx-onDurationTimer), a DRX deactivate time (drx-InactivityTimer), or the like.

Optionally, the antenna configuration of the terminal device may include at least one of the following: a quantity of antenna ports, an arrangement manner of an antenna port, an antenna type, or the like.

Optionally, the power parameter of the terminal device may include an uplink power parameter and/or a downlink power parameter of the terminal device. Optionally, the power parameter may include at least one of the following: maximum power information, power information for transmitting a control signal, power information for transmitting a data signal, or power information for transmitting each of at least one control signals. Optionally, the at least one control signal may include at least one uplink control signal and/or at least one downlink control signal.

Optionally, the power consumption mode of the terminal device includes a normal mode and a power saving mode. Optionally, an uplink and a downlink of the terminal device may share one power consumption mode. Optionally, the power consumption mode of the terminal device may include an uplink power consumption mode and/or a downlink power consumption mode. Optionally, the power consumption mode of the terminal device may include a power consumption mode requested by the terminal device to be configured.

In some embodiments, the uplink transmission parameter includes at least one of the following: a maximum quantity of uplink transmission layers, an uplink beam direction, an uplink minimum modulation and coding scheme (MCS), an uplink maximum MCS, an uplink average MCS, an uplink beam indication, or a spatial domain transmission filter indication.

In some embodiments, the downlink transmission parameter includes at least one of the following: a maximum quantity of downlink transmission layers, a downlink beam direction, a downlink minimum MCS, a downlink maximum MCS, a downlink average MCS, a downlink beam indication, or a spatial domain receive filter indication.

Optionally, the uplink beam direction may be included in a preconfigured uplink beam direction set. Optionally, the downlink beam direction may be included in a preconfigured downlink beam direction set.

Optionally, the minimum MCS may be a minimum-level MCS or a lowest-order MCS in some other embodiments, the maximum MCS may be a maximum-level MCS or a highest-order MCS in some other embodiments, and the average MCS may be an average-level MCS in some other embodiments.

Optionally, the uplink and/or downlink beam indication may include a beam index. Optionally, the spatial domain transmission filter and/or spatial domain receive filter indication may include a spatial domain transmission filter and/or spatial domain receive filter index.

In some embodiments, the first uplink resource is a resource in a first uplink cell, and the preconfigured uplink resource includes a resource in the first uplink cell and/or a second uplink cell.

Optionally, the preconfigured downlink resource includes a resource in a first downlink cell and/or a second downlink cell.

Optionally, the first uplink cell may be understood as a first uplink carrier, and the second uplink cell may be understood as a second uplink carrier. Optionally, the first downlink cell may be understood as a first downlink carrier, and the second downlink cell may be understood as a second downlink carrier. Optionally, the first uplink carrier and the first downlink carrier may be a same carrier or different carriers. Optionally, the second uplink carrier and the second downlink carrier may be a same carrier or different carriers.

Optionally, the first information may be used to indicate activating and/or deactivating a preconfigured resource on at least one of the following cells: the first uplink cell, the first downlink cell, the second uplink cell, or the second downlink cell. Optionally, at least one of the first downlink cell, the second uplink cell, or the second downlink cell may be preconfigured.

In some embodiments, that a terminal device determines a first uplink resource may include: determining, by the terminal device, the first uplink resource in the first uplink cell.

Optionally, the first uplink resource includes at least one resource in the preconfigured uplink resource.

Optionally, the first uplink resource does not belong to a resource in the preconfigured uplink resource, or the first uplink resource does not overlap a resource in the preconfigured uplink resource in time domain, or the first uplink resource does not overlap a resource in the preconfigured uplink resource in frequency domain.

In some embodiments, the first information may be used to indicate at least one of the following: activating a preconfigured uplink resource on the first uplink cell, activating a preconfigured downlink resource on the first downlink cell, deactivating a preconfigured uplink resource on the first uplink cell, deactivating a preconfigured downlink resource on the first downlink cell, activating a preconfigured uplink resource on the second uplink cell, activating a preconfigured downlink resource on the second downlink cell, deactivating a preconfigured uplink resource on the second uplink cell, or deactivating a preconfigured downlink resource on the second downlink cell.

Optionally, the first uplink cell and/or the first downlink cell may include one or more cells, and the second uplink cell and/or the second downlink cell may include one or more cells.

Optionally, the second uplink cell may be a part or all of cells, except for the first uplink cell, for a carrier aggregation working mode of the terminal device.

In some implementation scenarios, the terminal device sends information to the network device through the first uplink cell and/or the second uplink cell. In a case that the terminal device may send the first information through the first uplink cell, and the first information indicates deactivating a preconfigured uplink resource on the first uplink cell, or the first information indicates deactivating a preconfigured uplink resource, the terminal device will not send information on the first uplink cell, and the network device will not perform detection on the first uplink cell; and/or in a case that the terminal device sends the first information through the first uplink cell or the second uplink cell, and the first information indicates deactivating a preconfigured uplink resource on the second uplink cell, the terminal device will not send information on the first uplink cell or the second uplink cell, and the network device will not perform detection on the first uplink cell or the second uplink cell; and/or in a case that the terminal device sends the first information through the first uplink cell or the second uplink cell, and the first information indicates activating a preconfigured uplink resources on the first uplink cell and the second uplink cell, the terminal device may send information on the first uplink cell and the second uplink cell, and the network device will perform detection on the first uplink cell and the second uplink cell.

In some embodiments, for the terminal device, the method further includes: determining, by the terminal device, behavior of the terminal device based on the first information, where the behavior of the terminal device includes at least one of the following cases:
in a case that the first information is used to indicate a request to deactivate a preconfigured uplink resource, determining, by the terminal device, that a resource starting from the Nₜₕ resource in the preconfigured uplink resource is an invalid preconfigured uplink resource, where N is an integer greater than or equal to 1;
in a case that the first information is used to indicate a request to activate a preconfigured uplink resource, determining, by the terminal device, that a resource starting from the M^{th} resource in the preconfigured uplink resource is a valid preconfigured uplink resource, where M is an integer greater than or equal to 1;
in a case that the first information is used to indicate a request to deactivate a preconfigured downlink resource, determining, by the terminal device, that a resource starting from the N^{th} resource in the preconfigured downlink resource is an invalid preconfigured downlink resource, where N is an integer greater than or equal to 1; or
in a case that the first information is used to indicate a request to activate a preconfigured downlink resource, determining, by the terminal device, that a resource starting from the M^{th} resource in the preconfigured downlink resource is a valid preconfigured downlink resource, where M is an integer greater than or equal to 1.

In some embodiments, for the network device, the method further includes:
determining, by the network device, behavior of the network device based on the first information, where the behavior of the network device includes at least one of the following cases:
in a case that the first information is used to indicate a request to deactivate a preconfigured uplink resource, determining, by the network device, that a resource starting from the N^{th} resource in the preconfigured uplink resource is an invalid preconfigured uplink resource, where N is an integer greater than or equal to 1;
in a case that the first information is used to indicate a request to activate a preconfigured uplink resource, determining, by the network device, that a resource starting from the M^{th} resource in the preconfigured uplink resource is a valid preconfigured uplink resource, where M is an integer greater than or equal to 1;
in a case that the first information is used to indicate a request to deactivate a preconfigured downlink resource, determining, by the network device, that a resource starting from the N^{th} resource in the preconfigured downlink resource is an invalid preconfigured downlink resource, where N is an integer greater than or equal to 1; or
in a case that the first information is used to indicate a request to activate a preconfigured downlink resource, determining, by the network device, that a resource starting from the M^{th} resource in the preconfigured downlink resource is a valid preconfigured downlink resource, where M is an integer greater than or equal to 1.

Optionally, one resource may be a resource for one or more time units. For example, one resource may be a resource on one slot. For example, the M^{th} resource or the N^{th} resource may be a resource on the M^{th} slot or the N^{th} slot.

Optionally, for an invalid preconfigured uplink resource, the terminal device does not send information on the invalid preconfigured uplink resource, and the network device does not perform detection on the invalid preconfigured uplink resource.

Optionally, for a valid preconfigured uplink resource, the terminal device may send information or not send information on the valid preconfigured uplink resource, and the network device needs to perform detection on the valid preconfigured uplink resource.

Optionally, for an invalid preconfigured downlink resource, the network device does not send information on the invalid preconfigured downlink resource, and the terminal device does not perform detection on the invalid preconfigured downlink resource.

Optionally, for a valid preconfigured downlink resource, the network device may send information or not send information on the valid preconfigured downlink resource, and the terminal device needs to perform detection on the valid preconfigured downlink resource.

Optionally, performing detection on a resource includes performing monitoring on a resource and/or performing receiving on a resource.

In some embodiments, in a case that the first information is used to indicate deactivating a preconfigured uplink and/or downlink resource, information is not transmitted starting from the N^{th} resource in the preconfigured uplink and/or downlink resource.

In some embodiments, in a case that the first information is used to indicate activating a preconfigured uplink and/or downlink resource, information is transmitted or not transmitted starting from the M^{th} resource in the preconfigured uplink and/or downlink resource.

In some implementations, when the first information is used to indicate deactivating a preconfigured uplink resource, the terminal device performs no transmission starting from the N^{th} resource in the preconfigured uplink resource, and correspondingly, the network device may performs no detection starting from the N^{th} resource in the preconfigured uplink resource; and/or when the first information is used to indicate activating a preconfigured uplink resource, the terminal device may perform transmission or perform no transmission starting from the M^{th} resource in the preconfigured uplink resource, and correspondingly, the network device may perform detection starting from the M^{th} resource in the preconfigured uplink resource.

In some implementations, when the first information is used to indicate deactivating a preconfigured downlink resource, the network device performs no transmission starting from the N^{th} resource in the preconfigured downlink resource, and correspondingly, the terminal device may perform no detection starting from the N^{th} resource in the preconfigured downlink resource; and/or when the first information is used to indicate activating a preconfigured downlink resource, the network device may perform transmission or perform no transmission starting from the M^{th} resource in the preconfigured downlink resource, and correspondingly, the terminal device may perform detection starting from the M^{th} resource in the preconfigured downlink resource.

Optionally, N and/or M may be integers greater than or equal to 1. For example, N may be 1, 2, or 3, and M may be 1, 2, or 3. M and N may be the same or different.

Optionally, M and/or N may be preconfigured, or M and/or N may be configured by the network device for the terminal device, or M and/or N may be configured by the terminal device for the network device.

Optionally, the first information may be further used to indicate M and/or N, or M and/or N may be determined based on certain information indicated by the first information.

For example, if N is greater than or equal to 2, in a case that the first information is used to indicate deactivating a preconfigured uplink and/or downlink resource, information is transmitted on the first (N−1) resources in the preconfigured uplink and/or downlink resource, and information is not transmitted starting from the N^{th} resource in the preconfigured uplink resource; and/or information is detected on the first (N−1) resources in the preconfigured uplink and/or downlink resource, and information is not detected starting from the N^{th} resource in the preconfigured uplink resource.

For example, if M is greater than or equal to 2, in a case that the first information is used to indicate activating a preconfigured uplink and/or downlink resource, information is not transmitted on the first (M−1) resources in the preconfigured uplink and/or downlink resource, and information is transmitted starting from the M^{th} resource in the preconfigured uplink resource; and/or information is not detected on the first (M−1) resources in the preconfigured uplink and/or downlink resource, and information is detected starting from the M^{th} resource in the preconfigured uplink resource.

In some embodiments, for the terminal device, the method further includes: determining, by the terminal device, behavior of the terminal device based on the first information, where the behavior of the terminal device includes at least one of the following cases:
in a case that the first information is used to indicate a request to deactivate a resource within a first time period in a preconfigured uplink resource, determining, by the terminal device, that a resource within the first time period starting from the N^{th} resource in the preconfigured uplink resource is an invalid preconfigured uplink resource, where N is an integer greater than or equal to 1;
in a case that the first information is used to indicate a request to activate a resource within a second time period in a preconfigured uplink resource, determining, by the terminal device, that a resource within the second time period starting from the M^{th} resource in the preconfigured uplink resource is a valid preconfigured uplink resource, where M is an integer greater than or equal to 1;
in a case that the first information is used to indicate a request to deactivate a resource within a first time period in a preconfigured downlink resource, determining, by the terminal device, that a resource within the first time period starting from the N^{th} resource in the preconfigured downlink resource is an invalid preconfigured downlink resource, where N is an integer greater than or equal to 1; or in a case that the first information is used to indicate a request to activate a resource within a second time period in a preconfigured downlink resource, determining, by the terminal device, that a resource within the second time period starting from the M^{th} resource in the preconfigured downlink resource is a valid preconfigured downlink resource, where M is an integer greater than or equal to 1.

In some embodiments, for the network device, the method further includes:
determining, by the network device, behavior of the network device based on the first information, where the behavior of the network device includes at least one of the following cases:
in a case that the first information is used to indicate a request to deactivate a resource within a first time period in a preconfigured uplink resource, determining, by the network device, that a resource within the first time period starting from the N^{th} resource in the preconfigured uplink resource is an invalid preconfigured uplink resource, where N is an integer greater than or equal to 1;
in a case that the first information is used to indicate a request to activate a resource within a second time period in a preconfigured uplink resource, determining, by the network device, that a resource within the second time period starting from the M^{th} resource in the preconfigured uplink resource is a valid preconfigured uplink resource, where M is an integer greater than or equal to 1;
in a case that the first information is used to indicate a request to deactivate a resource within a first time period in a preconfigured downlink resource, determining, by the network device, that a resource within the first time period starting from the N^{th} resource in the preconfigured downlink resource is an invalid preconfigured downlink resource, where N is an integer greater than or equal to 1; or
in a case that the first information is used to indicate a request to activate a resource within a second time period in a preconfigured downlink resource, determining, by the network device, that a resource within the second time period starting from the M^{th} resource in the preconfigured downlink resource is a valid preconfigured downlink resource, where M is an integer greater than or equal to 1.

In some embodiments, in a case that the first information is used to indicate deactivating a resource within a first time period in a preconfigured uplink and/or downlink resource, information is not transmitted within the first time period starting from the N^{th} resource in the preconfigured uplink and/or downlink resource.

In some embodiments, in a case that the first information is used to indicate activating a resource within a second time period in a preconfigured uplink and/or downlink resource, information is transmitted or not transmitted within the second time period starting from the M^{th} resource in the preconfigured uplink and/or downlink resource.

In some implementations, when the first information is used to indicate deactivating a preconfigured uplink resource, the terminal device does not perform transmission within a first time period starting from the N^{th} resource in the preconfigured uplink resource, and/or the network device does not perform detection within the first time period; or when the first information is used to indicate activating a preconfigured uplink resource, the terminal device may perform transmission or not perform transmission within a second time period starting from the M^{th} resource in the preconfigured uplink resource, and/or the network device performs detection within the second time period.

In some implementations, when the first information is used to indicate deactivating a preconfigured downlink resource, the network device does not perform transmission within a first time period starting from the N^{th} resource in the preconfigured downlink resource, and/or the terminal device does not perform detection within the first time period; or when the first information is used to indicate activating a preconfigured downlink resource, the network device may perform transmission or not perform transmission within a second time period starting from the M^{th} resource in the preconfigured downlink resource, and/or the terminal device performs detection within the second time period.

Optionally, the first time period may be first duration in some other embodiments, and the second time period may be second duration in some other embodiments.

Optionally, a start moment of the first time period may be a start moment of the N^{th} resource, or an end moment of the first uplink resource, or an end moment of a time unit in which the first uplink resource is located, or at a first time interval from an end moment of the first uplink resource, or at a first time interval from an end moment of a time unit in which the first uplink resource is located.

Optionally, a start moment of the second time period may be a start moment of the M^{th} resource, or an end moment of the first uplink resource, or an end moment of a time unit in which the first uplink resource is located, or at a second time interval from an end moment of the first uplink resource, or at a second time interval from an end moment of a time unit in which the first uplink resource is located.

Optionally, the first information may be further used to indicate the first time period and/or the second time period, or the first time period and/or the second time period may be determined based on certain information indicated by the first information. Optionally, the first time period and/or the second time period may be preconfigured by the terminal device and/or the network device, or may be determined and configured for the network device by the terminal device, or may be determined and configured for the terminal device by the network device.

In some embodiments, for the terminal device, the determining, by the terminal device, behavior of the terminal device based on the first information includes: determining, by the terminal device, the behavior of the terminal device based on second information, where the second information is sent by the network device, and the second information is used to determine the behavior of the terminal device; or the second information has an association relationship with the first information; or the second information is determined by the network device based on the first information.

In some embodiments, for the terminal device, before the determining, by the terminal device, behavior of the terminal device based on the first information, the method further includes: receiving, by the terminal device, second information, where the second information is feedback information of the first information; or the second information is used to determine the behavior of the terminal device; or the second information is determined by the network device based on the first information.

In some embodiments, for the network device, the determining, by the network device, behavior of the network device based on the first information includes: determining, by the network device, the behavior of the network device based on second information, where the second information is sent by the network device to the terminal device, and the second information is used to determine the behavior of the network device and/or the terminal device; or the second information has an association relationship with the first information; or the second information is determined by the network device based on the first information.

In some embodiments, for the network device, before the determining, by the network device, behavior of the network device based on the first information, the method further includes: sending, by the network device, second information, where the second information is feedback information of the first information; or the second information is used to determine the behavior of the terminal device; or the second information is determined by the network device based on the first information.

Optionally, the feedback information may include acknowledgment information such as an ACK or negative acknowledgment information such as a NACK; or the feedback information may include only acknowledgment information. Optionally, the acknowledgment information or the negative acknowledgment information may be indicated by one or more bits, or the acknowledgment information may be indicated in an explicit manner.

Optionally, in a case that the feedback information of the first information is acknowledgment information of the first information, the terminal device and/or the network device may determine the behavior of the terminal device and/or the network device based on the first information. Optionally, in a case that the feedback information of the first information is negative acknowledgment information of the first information, the terminal device and/or the network device may not determine the behavior of the terminal device and/or the network device based on the first information.

Optionally, the feedback information may further include fourth information determined based on the first information. Optionally, the fourth information may be information obtained by modifying the first information. For example, in a case that the first information indicates a request to deactivate a resource within a first time period in a preconfigured uplink resource, the fourth information may indicate deactivating a resource within a third time period in a preconfigured uplink resource. The third time period is different from the first time period. For another example, the first information indicates that the uplink service type of the terminal device is a video service, and the fourth information may indicate activating a preconfigured downlink resource.

In some embodiments, the N^{th} resource is the 1st resource following the first uplink resource. Optionally, the last time unit of the time units corresponding to the first uplink resource and the start time unit of the time units corresponding to the N^{th} resource are adjacent time units. For example, the end symbol of the last slot of the slots corresponding to the first uplink resource and the start symbol of the first slot of the slots corresponding to the N^{th} resource are adjacent symbols.

In some other embodiments, the N^{th} resource is the 1st resource after a first time interval following the first uplink resource. Optionally, an interval between the last time unit of the time units corresponding to the first uplink resource and the start time unit of the time units corresponding to the N^{th} resource is greater than or equal to the first time interval. For example, an interval between the last symbol of the symbols corresponding to the first uplink resource and the start symbol of the symbols corresponding to the N^{th} resource is greater than or equal to the first time interval.

Optionally, the first time interval may include at least one of the following: one or more symbols, one or more slots, one or more subframes, or one or more system frames.

In some embodiments, the M^{th} resource is the 1st resource following the first uplink resource. Optionally, the last time unit of the time units corresponding to the first uplink resource and the start time unit of the time units corresponding to the M^{th} resource are adjacent time units. For example, the end symbol of the last slot of the slots corresponding to the first uplink resource and the start symbol of the first slot of the slots corresponding to the M^{th} resource are adjacent symbols.

In some other embodiments, the M^{th} resource is the 1st resource after a second time interval following the first uplink resource. Optionally, an interval between the last time unit of the time units corresponding to the first uplink resource and the start time unit of the time units corresponding to the M^{th} resource is greater than or equal to the second time interval. For example, an interval between the last symbol of the symbols corresponding to the first uplink resource and the start symbol of the symbols corresponding to the M^{th} resource is greater than or equal to the second time interval.

Optionally, the second time interval may include at least one of the following: one or more symbols, one or more slots, one or more subframes, or one or more system frames.

In some embodiments, the first time interval and the second time interval are a same time interval. For example, both the first time interval and the second time interval are half a slot.

In some other embodiments, the first time interval and the second time interval are determined based on same configuration information. Optionally, the configuration information for determining the first time interval and/or the second time interval may be predetermined by the terminal device and the network device, or may be determined and configured for the terminal device by the network device, or may be determined and configured for the network device by the terminal device.

In still some other embodiments, the first time interval is predefined, or is configured by the network device, and/or the second time interval is predefined, or is configured by the network device. For example, the first time interval and/or the second time interval may be preconfigured, or may be determined and sent to the network device by the terminal device, or may be determined and configured for the terminal device by the network device.

In still some other embodiments, the first time interval is associated with a subcarrier spacing, and/or the second time interval is associated with a subcarrier spacing.

Optionally, the first time interval and/or the second time interval may be determined based on a subcarrier spacing and a preset mathematical formula. Optionally, in a case that the subcarrier spacing is relatively high, the first time interval and/or the second time interval may be relatively small, and/or in a case that the subcarrier spacing is relatively low, the first time interval and/or the second time interval may be relatively large. Optionally, in a case that the subcarrier spacing is relatively high, the first time interval and/or the second time interval may be relatively large, and/or in a case that the subcarrier spacing is relatively low, the first time interval and/or the second time interval may be relatively small.

In some embodiments, the preconfigured uplink resource is determined based on first configuration information, and/or the preconfigured downlink resource is determined based on the first configuration information.

Optionally, before the terminal device determines the first information, the method further includes: receiving, by the terminal device, first configuration information sent by the network device. Optionally, the first configuration information is used to indicate a preconfigured uplink resource of the terminal device, and/or the terminal device determines the preconfigured uplink resource of the terminal device based on the first configuration information. Optionally, the first configuration information is used to indicate a preconfigured downlink resource of the terminal device, and/or the terminal device determines the preconfigured downlink resource of the terminal device based on the first configuration information.

Optionally, the first configuration information may be preconfigured configuration information, or may be information configured by the network device for the terminal device, or may be information configured by the terminal device for the network device. Optionally, the first configuration information may include an indication of or a description of a preconfigured uplink resource and/or a preconfigured downlink resource.

Optionally, the first configuration information may indicate an uplink resource and/or a downlink resource of at least one of one or more system frames, one or more subframes, one or more slots, or one or more symbols, so that the preconfigured uplink resource and/or the preconfigured downlink resource can be determined based on the uplink resource and/or the downlink resource indicated by the first configuration information. Optionally, the uplink resource and/or the downlink resource indicated by the first configuration information may be determined as the preconfigured uplink resource and/or the preconfigured downlink resource. Optionally, the preconfigured uplink resource and/or the preconfigured downlink resource may be a periodic resource or an aperiodic resource.

In some embodiments, the first configuration information is carried in at least one of the following: system information (SI), a radio resource control (RRC) message, a media access control control element (MAC CE), or downlink control information (DCI).

Optionally, the first configuration information may be carried in other information, which is not limited in embodiments of this application.

In some embodiments, the preconfigured uplink resource includes at least one of the following: a PUCCH resource, a configured grant-physical uplink shared channel CG-PUSCH resource, a physical random access channel PRACH resource, or a sounding reference signal (SRS) resource.

Optionally, the preconfigured uplink resource may further include another uplink resource, which is not limited in embodiments of this application.

Optionally, the PUCCH resource included in the preconfigured uplink resource is used to transmit an SR; and/or the PUCCH resource included in the preconfigured uplink resource is used to transmit a HARQ-ACK; and/or the PUCCH resource included in the preconfigured uplink resource is used to transmit CSI; and/or the PUCCH resource included in the preconfigured uplink resource is associated with a first spatial domain filter, a first beam direction, or the first beam indication.

Optionally, the CG-PUSCH resource included in the preconfigured uplink resource is used to transmit an uplink service. Optionally, the CG-PUSCH resource is associated with a first spatial domain filter, a first beam direction, or the first beam indication.

Optionally, the PRACH resource included in the preconfigured uplink resource is a dedicated PRACH resource; and/or the PRACH resource included in the preconfigured uplink resource is associated with a first spatial domain filter, a first beam direction, or the first beam indication; and/or the PRACH resource included in the preconfigured uplink resource is used for beam failure recovery (BFR).

Optionally, the SRS resource included in the preconfigured uplink resource is a periodic SRS resource configured for the terminal device; and/or the SRS resource included in the preconfigured uplink resource is at least one SRS resource set in P SRS resource sets configured for the terminal device, where P is greater than or equal to 1; and/or the SRS resource included in the preconfigured uplink resource is associated a first spatial domain filter, a first beam direction, or the first beam indication.

Optionally, the first spatial domain filter may include a first spatial domain transmission filter. Optionally, a first beam may include a first transmit beam.

In an example, the preconfigured uplink resource is associated with the first spatial domain transmission filter or the first beam direction. When the first information is used to indicate deactivating a preconfigured uplink resource, the first information is used to indicate a request to deactivate a resource associated with the first spatial domain transmission filter or the first beam direction in the preconfigured uplink resource.

In some embodiments, the preconfigured downlink resource includes at least one of the following: a PDCCH resource, a semi-persistent scheduling-physical downlink shared channel (SPS-PDSCH) resource, a synchronization signal block SSB resource, or a channel state information-reference signal CSI-RS resource.

Optionally, the preconfigured downlink resource is associated with a second spatial domain filter, a second beam direction, or the second beam indication. Optionally, the second spatial domain filter may include a first spatial domain receive filter. Optionally, a second beam may include a first receive beam.

In an example, the preconfigured downlink resource is associated with the first spatial domain receive filter or the second beam direction. When the first information is used to indicate deactivating a preconfigured downlink resource, the first information is used to indicate a request to deactivate a resource associated with the first spatial domain receive filter or the second beam direction in the preconfigured downlink resource.

Optionally, the spatial domain transmission filter may be referred to as a spatial filter for transmission, and the spatial domain receive filter may be referred to as a spatial filter for reception. Optionally, the spatial domain transmission filter may also be referred to as a spatial domain transmit filter in some embodiments.

Optionally, the preconfigured downlink resource may further include another downlink resource, which is not limited in embodiments of this application.

In some embodiments, the terminal device may determine the first information by itself and/or determine reporting of the first information by itself. For example, the terminal device may determine the first information based on preconfiguration information, and send the first information to the network device. In some other embodiments, the terminal device may send the first information to the network device based on second configuration information configured by the network device.

In some embodiments, for the terminal device, the method further includes: receiving, by the terminal device, second configuration information. For the network device, the method further includes: sending, by the network device, second configuration information.

The second configuration information is used to indicate at least one of the following: configuring the terminal device to report the first information, configuring the first uplink resource, triggering the terminal device to report the first information, or reporting or skipping reporting the first information by the terminal device.

Optionally, an implementation of a scheme of triggering the terminal device to report the first information includes: when signalling that carries the second configuration information appears, the terminal performs reporting; and when the signalling does not appear, the terminal does not perform reporting.

Optionally, an implementation of a scheme of indicating the reporting or skipping reporting the first information by the terminal device includes: signalling that carries the second configuration information may include indication information of 1 bit, and when the bit indicates “1”, the terminal performs reporting; and when the bit indicates “0”, the terminal does not perform reporting.

In some embodiments, in a case that the second configuration information indicates configuring the terminal device to report the first information, the terminal device may determine, based on the second configuration information, the first uplink resource used for sending the first information and/or the first information, and send the first information by using the first uplink resource. In some other embodiments, in a case that the second configuration information indicates configuring the first uplink resource, the terminal device may determine the first uplink resource based on the second configuration information, and send the first information by using the first uplink resource. In still some other embodiments, in a case that the second configuration information indicates triggering the terminal device to report the first information, the terminal device may determine the first uplink resource and/or the first information based on preconfiguration information, and send the first information by using the first uplink resource. In yet some other embodiments, in a case that the second configuration information indicates reporting the first information, the terminal device may send the first information to the network device, or in a case that the second configuration information indicates skipping reporting the first information, the terminal device stops sending the first information to the network device, or the terminal device does not send the first information to the network device.

Optionally, the second configuration information may indicate at least one of the following through at least one of an explicit indication, an implicit indication, a direct indication, or an indirect indication: configuring the terminal device to report the first information, configuring the first uplink resource, triggering the terminal device to report the first information, or reporting or skipping reporting the first information by the terminal device.

In some embodiments, the second configuration information is carried in at least one of the following: system information, an RRC message, a MAC CE, DCI, or a wake-up signal (WUS).

Optionally, the second configuration information and the first configuration information may be carried in a same message/signalling, or the second configuration information and the first configuration information may be carried in different messages/signalling.

Optionally, in a case that the second configuration information is carried in a WUS, a wake-up receiver (WUR) of the terminal device receives the WUS, and the WUR of the terminal device may determine whether the first information exists in the WUS. In a case that it is determined that the first information exists in the WUS, and it is determined that the first information indicates activating a preconfigured resource (including a preconfigured uplink resource and/or a preconfigured downlink resource), the WUR of the terminal device may send the WUS to a master receiver to wake up the WUR, so that the master receiver sends information or receives information on the activated preconfigured resource. In some other embodiments, in a case that it is determined that the first information exists in the WUS, and it is determined that the first information indicates deactivating a preconfigured resource (including a preconfigured uplink resource and/or a preconfigured downlink resource), the WUR of the terminal device does not send the WUS to a master receiver, so that the master receiver can still be in a low power state.

Optionally, in a case that the second configuration information is carried in a WUS, a master receiver of the terminal device receives the WUS. Optionally, the master receiver may be an apparatus that may be configured to receive other signals besides the WUS in the embodiment of this application.

Optionally, in some embodiments, the second configuration information may be carried in uplink grant DCI. Optionally, in some other embodiments, the second configuration information may be carried in downlink grant DCI.

Optionally, the first uplink resource is a resource predefined by the terminal device.

Optionally, the first uplink resource is indicated by uplink grant DCI.

Optionally, the first uplink resource is indicated by downlink grant DCI.

Optionally, sending of the first information is triggered by uplink grant DCI.

Optionally, sending of the first information is triggered by downlink grant DCI.

In some embodiments, for the terminal device, the method further includes: sending, by the terminal device, third information, where the third information is used to indicate that the terminal device has a capability of sending the first information; or the third information is used to indicate that the terminal device supports a UE capability of reporting the first information.

In some embodiments, for the network device, the method further includes: receiving, by the network device, third information, where the third information is used to indicate that the terminal device has a capability of sending the first information; or the third information is used to indicate that the terminal device supports a UE capability of reporting the first information.

Optionally, the third information may be carried in signalling sent by the terminal device to the network device in a random access process. Optionally, the third information may indicate, through at least one of an explicit indication, an implicit indication, a direct indication, or an indirect indication, that the terminal device has the capability of sending the first information.

In this way, the terminal device needs to first report to the network device that the terminal device has the capability of reporting the first information, and then the network device configures the terminal device with an uplink resource used for reporting the first information. In this case, the terminal device reports the first information to the network device, and correspondingly, the network device receives the first information sent by the terminal device, or the network device triggers the terminal device to report the first information. If the terminal device does not report to the network device that the terminal device has the capability of reporting the first information, the network device does not configure the terminal device with an uplink resource used for reporting the first information, and does not receive the first information sent by the terminal device, or the network device does not trigger the terminal device to report the first information.

In some embodiments, the first uplink resource is a first physical uplink control channel PUCCH resource, and the first information is carried in a first PUCCH transmitted by using the first PUCCH resource.

In some embodiments, the first PUCCH resource is at least one of the following cases:
a quantity of bits carried by a PUCCH format corresponding to the first PUCCH resource is 1 or 2;
a quantity of bits carried by a PUCCH format corresponding to the first PUCCH resource is greater than 2;
the first PUCCH resource is used to transmit a scheduling request SR;
the first PUCCH resource is used to transmit a hybrid automatic repeat request-acknowledgment HARQ-ACK; or
the first PUCCH resource is used to transmit channel state information CSI.

Optionally, the first PUCCH resource may be used to transmit at least one of the following: a channel quality indicator (CQI), a rank indicator (RI), a precoding matrix indicator (PMI), or the like.

Optionally, the quantity of bits carried by the PUCCH format corresponding to the first PUCCH resource is 1 to 2 bits. For example, the PUCCH format corresponding to the first PUCCH resource may be a PUCCH format 0 or a PUCCH format 1.

Optionally, the quantity of bits carried by the PUCCH format corresponding to the first PUCCH resource is greater than 2 bits. For example, the PUCCH format corresponding to the first PUCCH resource may be a PUCCH format 2, a PUCCH format 3, or a PUCCH format 4.

Optionally, in a case that the first PUCCH resource is used to transmit a scheduling request SR, a quantity of bits corresponding to the first PUCCH resource is 1 to 2 bits, or may be greater than 2 bits. Optionally, in a case that the first PUCCH resource is used to transmit a hybrid automatic repeat request-acknowledgment HARQ-ACK, a quantity of bits corresponding to the first PUCCH resource may be 1 to 2 bits, or may be greater than 2 bits. Optionally, in a case that the first PUCCH resource is used to transmit channel state information CSI, a quantity of bits corresponding to the first PUCCH resource is greater than 2 bits.

Optionally, the HARQ-ACK may be separately transmitted on the first PUCCH resource. Optionally, the HARQ-ACK and the SR may be simultaneously transmitted on the first PUCCH resource. Optionally, the HARQ-ACK and the CSI may be simultaneously transmitted on the first PUCCH resource.

In some embodiments, when the first PUCCH resource is used to transmit a HARQ-ACK, the HARQ-ACK and the first information are jointly encoded, or the HARQ-ACK and the first information are separately encoded.

In some embodiments, when the first PUCCH resource is used to transmit CSI, the CSI and the first information are jointly encoded, or the CSI and the first information are separately encoded.

Optionally, when the first PUCCH resource is used to transmit an SR, the SR and the first information are jointly encoded, or the SR and the first information are separately encoded.

Optionally, when the first PUCCH resource is used to transmit at least one of a CQI, an RI, or a PMI, the first information and at least one of the CQI, the RI, or the PMI may be jointly encoded, or the first information and at least one of the CQI, the RI, or the PMI may be separately encoded.

In some embodiments, when the first PUCCH resource is used to transmit an SR, the first information is used to indicate a request to deactivate a resource within a first time period in a preconfigured uplink resource and/or a request to deactivate a resource within a first time period in a preconfigured downlink resource, where the first PUCCH resource has an association relationship with the first time period.

Optionally, the first time period may include one or more time periods. The plurality of time periods may be continuous or discontinuous time periods. Optionally, one time period may be one DTX cycle. For example, the first time period may include one DTX cycle, or the first time period may include a plurality of DTX cycles, and the plurality of DTX cycles are continuous or discontinuous or partially continuous. A first PUCCH resource within one DTX cycle may be associated with another DTX cycle.

Optionally, in a case that the first time period includes a plurality of time periods, the durations corresponding to the plurality of time periods may be the same, or the durations corresponding to at least two time periods in the plurality of time periods is different. The plurality of time periods may be preconfigured time periods, or the plurality of time periods may be time periods configured by the network device for the terminal device, or the plurality of time periods may be time periods configured by the terminal device for the network device. Optionally, one time period in the plurality of time periods may include at least one of the following: duration, a start moment, a start time unit, an end moment, or an end time unit.

Optionally, the SR may be transmitted on one or more time units at the end of one DTX cycle, that is, the first PUCCH resource may be one or more time units at the end of one DTX cycle.

Optionally, the first PUCCH resource may be a resource within a third time period. The third time period is one DTX cycle, the first time period may be one DTX cycle, the first time period may be a time period after the third time period, and the first time period and the third time period may be adjacent, or separated by at least one DTX cycle.

In some embodiments, the first PUCCH resource is associated with a first sequence and a second sequence.

Optionally, the first sequence and/or the second sequence may be used to indicate information of one or more bits. Optionally, the first sequence and the second sequence correspond to different cyclic shift values. The first sequence and/or the second sequence may be preconfigured, or may be generated based on preconfiguration information. Optionally, the first sequence and/or the second sequence may also be referred to as a first indication and/or a second indication in some other embodiments. Optionally, the descriptions of the first sequence and/or the second sequence may be applicable to different embodiments.

In some embodiments, for the terminal device, the first PUCCH resource is associated with a first sequence and a second sequence, and the method further includes:
when the terminal device determines that there is an SR requirement and the first information is not to be reported, transmitting, by the terminal device, the first sequence by using the first PUCCH resource; or
when the terminal device determines that there is no SR requirement and the first information is to be reported, transmitting, by the terminal device, the second sequence by using the first PUCCH resource; or
when the terminal device determines that there is no SR requirement and the first information is not to be reported, skipping, by the terminal device, performing transmission on the first uplink resource.

In some implementation scenarios, when the terminal device determines that there is an SR requirement and the first information is not to be reported, the terminal device transmits the first sequence by using the first PUCCH resource; or when the terminal device determines that there is no SR requirement and the first information is to be reported, the terminal device transmits the second sequence by using the first PUCCH resource; otherwise, the terminal device does not perform transmission on the first uplink resource.

In some embodiments, that the terminal device does not perform transmission on the first uplink resource may be understood as: the terminal device does not transmit any information on the first uplink resource, or may be understood as: the terminal device does not transmit the first information on the first uplink resource.

In some embodiments, for the network device, the first PUCCH resource is associated with a first sequence and a second sequence, and the method further includes:
when the network device detects the first sequence by using the first PUCCH resource, determining that the terminal device has an SR requirement and does not report the first information; or
when the network device detects the second sequence by using the first PUCCH resource, determining that the terminal device has no SR requirement and reports the first information; or
when the network device does not detect the first sequence or the second sequence by using the first PUCCH resource, determining that the terminal device has no SR requirement and does not report the first information.

In some implementation scenarios, when the network device detects the first sequence by using the first PUCCH resource, it is determined that the terminal device has an SR requirement and does not report the first information; or when the network device detects the second sequence by using the first PUCCH resource, it is determined that the terminal device has no SR requirement and reports the first information; otherwise, the network device determines that the terminal device has no SR requirement and does not report the first information.

In some embodiments, when the first PUCCH resource is used to transmit an SR, the first information is used to indicate a request to activate a resource within a second time period in a preconfigured uplink resource and/or a request to activate a resource within a second time period in a preconfigured downlink resource, where the first PUCCH resource has an association relationship with the second time period.

Optionally, the second time period may include one or more time periods. The plurality of time periods may be continuous or discontinuous time periods. Optionally, one time period may be one DTX cycle. For example, the second time period may include one DTX cycle, or the second time period may include a plurality of DTX cycles, and the plurality of DTX cycles are continuous or discontinuous or partially continuous. A first PUCCH resource within one DTX cycle may be associated with another DTX cycle.

Optionally, in a case that the second time period includes a plurality of time periods, the durations corresponding to the plurality of time periods may be the same, or the durations corresponding to at least two time periods in the plurality of time periods is different. The plurality of time periods may be preconfigured time periods, or the plurality of time periods may be time periods configured by the network device for the terminal device, or the plurality of time periods may be time periods configured by the terminal device for the network device. Optionally, one time period in the plurality of time periods may include at least one of the following: duration, a start moment, a start time unit, an end moment, or an end time unit.

Optionally, the SR may be transmitted on one or more time units at the end of one DTX cycle, that is, the first PUCCH resource may be one or more time units at the end of one DTX cycle.

Optionally, the first PUCCH resource may be a resource within a third time period. The third time period is one DTX cycle, the second time period may be one DTX cycle, the second time period may be a time period after the third time period, and the second time period and the third time period may be adjacent, or separated by at least one DTX cycle.

In some embodiments, for the terminal device, the first PUCCH resource is associated with a first sequence and a second sequence, and the method further includes:
when the terminal device determines that there is an SR requirement and the first information is to be reported, transmitting, by the terminal device, the first sequence by using the first PUCCH resource; or
when the terminal device determines that there is no SR requirement and the first information is to be reported, transmitting, by the terminal device, the second sequence by using the first PUCCH resource; or
when the terminal device determines that there is no SR requirement and the first information is not to be reported, skipping, by the terminal device, performing transmission on the first uplink resource.

In some implementation scenarios, when the terminal device determines that there is an SR requirement and the first information is to be reported, the terminal device transmits the first sequence by using the first PUCCH resource; or when the terminal device determines that there is no SR requirement and the first information is to be reported, the terminal device transmits the second sequence by using the first PUCCH resource; otherwise, the terminal device does not perform transmission on the first uplink resource.

In some embodiments, for the network device, the first PUCCH resource is associated with a first sequence and a second sequence, and the method further includes:
when the network device detects the first sequence by using the first PUCCH resource, determining that the terminal device has an SR requirement and reports the first information; or
when the network device detects the second sequence by using the first PUCCH resource, determining that the terminal device has no SR requirement and reports the first information; or
when the network device does not detect the first sequence or the second sequence by using the first PUCCH resource, determining that the terminal device has no SR requirement and does not report the first information.

In some implementation scenarios, when the network device detects the first sequence by using the first PUCCH resource, it is determined that the terminal device has an SR requirement and reports the first information; or when the network device detects the second sequence by using the first PUCCH resource, it is determined that the terminal device has no SR requirement and reports the first information; otherwise, the network device determines that the terminal device has no SR requirement and does not report the first information.

In some embodiments, for the terminal device, the first PUCCH resource is associated with a first sequence and a second sequence, and the method further includes:
when the terminal device determines that there is an SR requirement, transmitting, by the terminal device, the first sequence by using the first PUCCH resource; or
when the terminal device determines that there is no SR requirement and the first information is to be reported, transmitting, by the terminal device, the second sequence by using the first PUCCH resource; or
when the terminal device determines that there is no SR requirement and the first information is not to be reported, skipping, by the terminal device, performing transmission on the first uplink resource.

In some implementation scenarios, when the terminal device determines that there is an SR requirement, the terminal device transmits the first sequence by using the first PUCCH resource; or when the terminal device determines that there is no SR requirement and the first information is to be reported, the terminal device transmits the second sequence by using the first PUCCH resource; otherwise, the terminal device does not perform transmission on the first uplink resource.

In some embodiments, for the network device, the first PUCCH resource is associated with a first sequence and a second sequence, and the method further includes:
when the network device detects the first sequence by using the first PUCCH resource, determining that the terminal device has an SR requirement; or
when the network device detects the second sequence by using the first PUCCH resource, determining that the terminal device has no SR requirement and reports the first information; or
when the network device does not detect the first sequence or the second sequence by using the first PUCCH resource, determining that the terminal device has no SR requirement and does not report the first information.

In some implementation scenarios, when the network device detects the first sequence by using the first PUCCH resource, it is determined that the terminal device has an SR requirement; or when the network device detects the second sequence by using the first PUCCH resource, it is determined that the terminal device has no SR requirement and reports the first information; otherwise, the network device determines that the terminal device has no SR requirement and does not report the first information.

Optionally, in this embodiment, a priority of reporting the SR requirement is higher than that of reporting the first information.

In some embodiments, for the terminal device, the first PUCCH resource is associated with a first sequence and a second sequence, and the method further includes:
when the terminal device determines that the first information is to be reported, transmitting, by the terminal device, the first sequence by using the first PUCCH resource; or
when the terminal device determines that the first information is not to be reported and there is an SR requirement, transmitting, by the terminal device, the second sequence by using the first PUCCH resource; or
when the terminal device determines that the first information is not to be reported and there is no SR requirement, skipping, by the terminal device, performing transmission on the first uplink resource.

In some implementation scenarios, when the terminal device determines that the first information is to be reported, the terminal device transmits the first sequence by using the first PUCCH resource; or when the terminal device determines that the first information is not to be reported and there is an SR requirement, the terminal device transmits the second sequence by using the first PUCCH resource; otherwise, the terminal device does not perform transmission on the first uplink resource.

In some embodiments, for the network device, the first PUCCH resource is associated with a first sequence and a second sequence, and the method further includes:
when the network device detects the first sequence by using the first PUCCH resource, determining that the terminal device reports the first information; or
when the network device detects the second sequence by using the first PUCCH resource, determining that the terminal device does not report the first information and has an SR requirement; or
when the network device does not detect the first sequence or the second sequence by using the first PUCCH resource, determining that the terminal device does not report the first information and has no SR requirement.

In some implementation scenarios, when the network device detects the first sequence by using the first PUCCH resource, it is determined that the terminal device reports the first information; or when the network device detects the second sequence by using the first PUCCH resource, it is determined that the terminal device does not report the first information and has an SR requirement; otherwise, the network device determines that the terminal device does not report the first information and has no SR requirement.

Optionally, in this embodiment, a priority of reporting the first information is higher than that of reporting the SR requirement.

In some embodiments, a length of the first time period is the same as a length of the second time period. For example, the first time period is 10 slots, and the second time period is also 10 slots. In some other embodiments, a length of the first time period may be different from a length of the second time period.

In some other embodiments, the first time period and the second time period are determined based on same configuration information. Optionally, the configuration information may be preconfigured, or may be configured by the network device for the terminal device, or may be configured by the terminal device for the network device.

In still some other embodiments, the first time period is predefined, or is configured by the network device, and/or the second time period is predefined, or is configured by the network device. For example, the first time period and/or the second time period may be preconfigured, or may be determined and sent to the network device by the terminal device, or may be determined and configured for the terminal device by the network device.

In still some other embodiments, the first time period is determined based on a first time period set, the first time period set is predefined, or is configured by the network device, and the first time period set includes information about a plurality of time periods. For example, the first time period set may include one symbol, half a slot, one slot, and the like. In some embodiments, the first time period may be at least one time period in the first time period set. In some other embodiments, the first time period may be determined based on at least one time period in the first time period set.

In still some other embodiments, the second time period is determined based on a second time period set, the second time period set is predefined, or is configured by the network device, and the second time period set includes information about a plurality of time periods. For example, the second time period set may include one symbol, half a slot, one slot, and the like. In some embodiments, the second time period may be at least one time period in the second time period set. In some other embodiments, the second time period may be determined based on at least one time period in the second time period set.

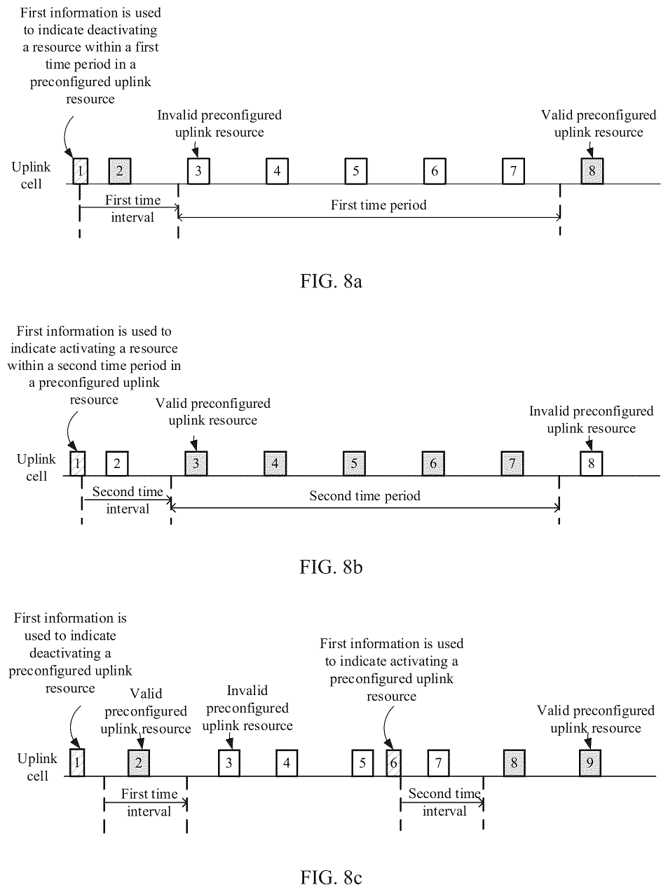

FIG. 8a is a schematic diagram of a manner of reporting first information by a terminal device according to an embodiment of this application. As shown in FIG. 8a, an uplink cell is used as an example. The terminal device determines a first uplink resource (a resource 1), and transmits the first information on the resource 1. The first information is used to indicate deactivating a resource within a first time period in a preconfigured uplink resource. In this case, resources 3 to 7 within a first time period after a first time interval following the resource 1 are invalid preconfigured uplink resources, and a resource 8 after the first time period and a resource 2 within the first time interval are valid preconfigured uplink resources.

FIG. 8b is a schematic diagram of another manner of reporting first information by a terminal device according to an embodiment of this application. As shown in FIG. 8b, an uplink cell is used as an example. The terminal device determines a first uplink resource (a resource 1), and transmits the first information on the resource 1. The first information is used to indicate activating a resource within a second time period in a preconfigured uplink resource. In this case, resources 3 to 7 within a second time period after a second time interval following the resource 1 are valid preconfigured uplink resources, and a resource 8 after the second time period and a resource 2 within the second time interval are invalid preconfigured uplink resources.

FIG. 8c is a schematic diagram of still another manner of reporting first information by a terminal device according to an embodiment of this application. As shown in FIG. 8c, an uplink cell is used as an example. The terminal device determines a first uplink resource (a resource 1), and transmits the first information on the resource 1. The first information is used to indicate deactivating a preconfigured uplink resource. In this case, all resources after a first time interval following the resource 1 are invalid preconfigured uplink resources. For example, in FIG. 8c, resources 3 to 5 are invalid preconfigured uplink resources, and a resource 2 within the first time interval is a valid preconfigured uplink resource. Then, the terminal device determines another first uplink resource (a resource 6), and transmits first information on the resource 6. The first information is used to indicate activating a preconfigured uplink resource. In this case, all resources after a second time interval following the resource 6 are valid preconfigured uplink resources. For example, in FIG. 8c, resources 8 to 9 are valid preconfigured uplink resources, and a resource 7 within the second time interval is an invalid preconfigured uplink resource.

In FIG. 8a to FIG. 8c, a valid preconfigured uplink resource is represented by a gray area, and an invalid preconfigured uplink resource is represented by a white area.

The terminal device may send uplink information by using a valid preconfigured uplink resource, and correspondingly, the network device performs detection on the valid preconfigured uplink resource. The terminal device does not send information on an invalid preconfigured uplink resource, and correspondingly, the network device does not perform detection on the invalid preconfigured uplink resource.

A transmission period configured by the network device for the terminal device may be associated with a PUCCH resource used for transmitting an SR, and the PUCCH resource is associated with a first sequence and a second sequence. For example, the first information transmitted on the first PUCCH resource is used to indicate activating or deactivating a preconfigured uplink resource within a first transmission period, where the first transmission period has an association relationship with the first PUCCH resource.

Optionally, the transmission period may include a DTX cycle and/or a DRX cycle.

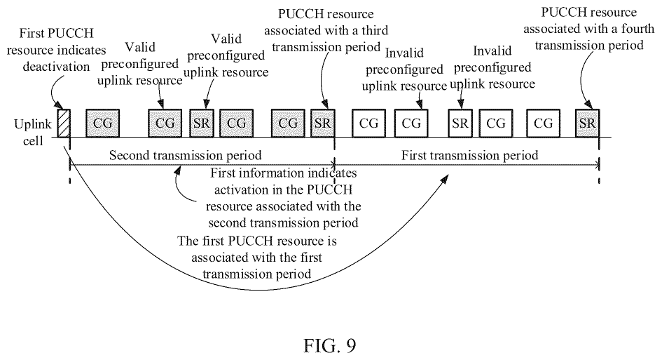

FIG. 9 is a schematic diagram of reporting first information by a terminal device by using an SR resource according to an embodiment of this application. As shown in FIG. 9, the first information may be used to indicate activation and/or deactivation, for example, indicate activation and/or deactivation of a preconfigured uplink resource, where the preconfigured uplink resource includes a PUCCH resource (represented by an SR in FIG. 9) used for transmitting an SR and a CG-PUSCH resource (represented by a CG in FIG. 9), and the terminal device reports the first information to the network device by using the PUCCH resource used for transmitting an SR.

As shown in FIG. 9, if the first information transmitted on the first PUCCH resource is used to indicate deactivation, resources other than an SR resource used for transmitting the first information within the first transmission period associated with the first PUCCH resource are invalid preconfigured uplink resources.

Within the second transmission period, if the first information in the PUCCH resource associated with the second transmission period indicates activation, all preconfigured uplink resources within the second transmission period are valid preconfigured uplink resources, and the terminal device may transmit uplink information or may not perform transmission by using the valid preconfigured uplink resource.

Optionally, within the first transmission period and/or the second transmission period, the SR resource used for transmitting the first information may be at least one SR resource within the first transmission period and/or the second transmission period. For example, the SR resource used for transmitting the first information may be the last SR resource within the first transmission period and/or the second transmission period.

The last SR resource in the second transmission period may be a PUCCH resource associated with a third transmission period, and the last SR resource in the first transmission period may be a PUCCH resource associated with a fourth transmission period.

In FIG. 9, a valid preconfigured uplink resource is represented by a gray area, and an invalid preconfigured uplink resource is represented by a white area.

Optionally, the third transmission period may be after the first transmission period, and the fourth transmission period may be after the third transmission period.

In some implementations, when the terminal device needs to send a scheduling request, the terminal device transmits the first sequence on the first PUCCH resource; or
when the terminal device needs to deactivate a preconfigured uplink resource within the first transmission period, the terminal device transmits the second sequence on the first PUCCH resource; or
when the terminal device does not need to send a scheduling request and does not need to deactivate a preconfigured uplink resource within the first transmission period, the terminal device does not perform transmission on the first PUCCH resource.

Optionally, the first sequence may indicate that the terminal device needs to send a scheduling request. Optionally, the second sequence may indicate that the terminal device needs to deactivate a preconfigured uplink resource within the first transmission period.

In some other implementations, when the terminal device needs to send a scheduling request, the terminal device transmits the first sequence on the first PUCCH resource; or
when the terminal device needs to activate a preconfigured uplink resource within the first transmission period, the terminal device transmits the second sequence on the first PUCCH resource; or
when the terminal device does not need to send a scheduling request and deactivates a preconfigured uplink resource within the first transmission period, the terminal device does not perform transmission on the first PUCCH resource.

Optionally, the first sequence may indicate that the terminal device needs to send a scheduling request. Optionally, the second sequence may indicate that the terminal device needs to activate a preconfigured uplink resource within the first transmission period.

In still some other implementations, when the terminal device needs to send a scheduling request and activate a preconfigured uplink resource within the first transmission period, the terminal device transmits the first sequence on the first PUCCH resource; or
when the terminal device does not need to send a scheduling request and activates a preconfigured uplink resource within the first transmission period, the terminal device transmits the second sequence on the first PUCCH resource; or
when the terminal device does not need to send a scheduling request and deactivates a preconfigured uplink resource within the first transmission period, the terminal device does not perform transmission on the first PUCCH resource.

Optionally, the first sequence may indicate that the terminal device needs to send a scheduling request and activates a preconfigured uplink resource within the first transmission period. Optionally, the second sequence may indicate that the terminal device does not need to send a scheduling request and activates a preconfigured uplink resource within the first transmission period.

In still some other implementations, when the terminal device needs to send a scheduling request and activates a preconfigured uplink resource within the first transmission period, the terminal device transmits the first sequence on the first PUCCH resource; or
when the terminal device does not need to send a scheduling request and deactivates a preconfigured uplink resource within the first transmission period, the terminal device transmits the second sequence on the first PUCCH resource; or
when the terminal device does not need to send a scheduling request and activates a preconfigured uplink resource within the first transmission period, the terminal device does not perform transmission on the first PUCCH resource.

Optionally, the first sequence may indicate that the terminal device needs to send a scheduling request and activates a preconfigured uplink resource within the first transmission period. Optionally, the second sequence may indicate that the terminal device does not need to send a scheduling request and deactivates a preconfigured uplink resource within the first transmission period.

Optionally, the terminal device does not report a state in which a scheduling request does not need to be sent and a preconfigured uplink resource within the first transmission period is to be deactivated, or the network device does not expect the terminal device to report a state in which a scheduling request does not need to be sent and a preconfigured uplink resource within the first transmission period is to be deactivated.

In this embodiment of this application, in an NR system and an evolved system thereof, through the scheme provided in this application, a network device may dynamically activate or deactivate a preconfigured uplink transmission resource for a terminal device, so as to achieve the purpose of network energy saving.

The foregoing describes in detail the preferred implementations of this application with reference to the accompanying drawings. However, this application is not limited to specific details of the foregoing implementations. Within a technical concept scope of this application, a plurality of simple variations of the technical solutions of this application may be performed, and these simple variations are all within the protection scope of this application. For example, each specific technical feature described in the foregoing specific implementations may be combined in any suitable manner without contradiction. To avoid unnecessary repetition, various possible combination manners are not described otherwise in this application. For another example, any combination may also be performed between different implementations of this application, provided that the combination is not contrary to the idea of this application, the combination shall also be considered as the content disclosed in this application. For another example, without a conflict, the embodiments and/or the technical features in the embodiments described in this application may be randomly combined with the prior art, and the technical solutions obtained after the combination also fall within the protection scope of this application.

It should be further understood that, in the method embodiments of this application, sequence numbers of the foregoing processes do not mean execution sequences. The execution sequences of the processes shall be determined according to functions and internal logic of the processes, and shall not be construed as any limitation on the implementation processes of embodiments of this application. In addition, in embodiments of this application, the terms “downlink”, “uplink”, and “sidelink” are used to indicate a transmission direction of a signal or data, where “downlink” indicates that a transmission direction of a signal or data is a first direction from a station to user equipment in a cell, “uplink” indicates that a transmission direction of a signal or data is a second direction from user equipment in a cell to a station, and “sidelink” indicates that a transmission direction of a signal or data is a third direction from user equipment 1 to user equipment 2. For example, a “downlink signal” indicates that a transmission direction of the signal is the first direction. In addition, in embodiments of this application, the term “and/or” is merely used to describe an association relationship between associated objects, and represents that there may be three relationships. Specifically, A and/or B may represent three cases: only A exists, both A and B exist, and only B exists. In addition, the character “/” in this specification generally indicates an “or” relationship between the associated objects.

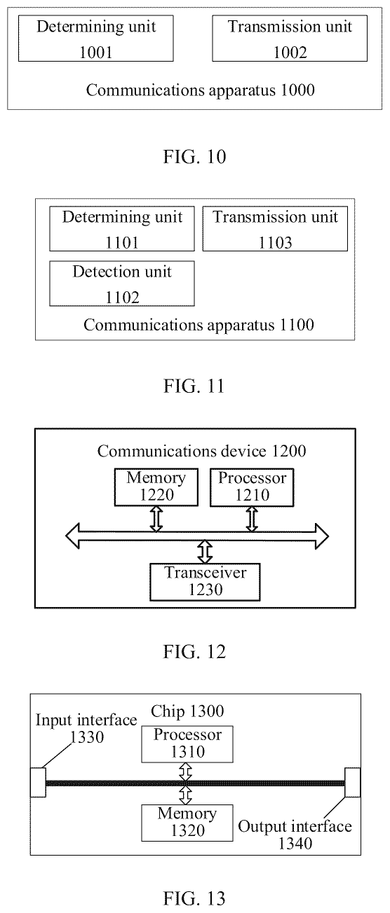

FIG. 10 is a schematic diagram of a structural composition of a communications apparatus according to an embodiment of this application, which is applied to a terminal device. As shown in FIG. 10, the communications apparatus 1000 includes:
a determining unit 1001, configured to determine a first uplink resource, where the first uplink resource is used to transmit first information; and
a transmission unit 1002, configured to transmit the first information on the first uplink resource, or skip transmitting the first information on the first uplink resource.

In some embodiments, the first information is used to indicate at least one of the following:
a request to deactivate a preconfigured uplink resource, a request to activate a preconfigured uplink resource, a request to deactivate a resource within a first time period in a preconfigured uplink resource, a request to activate a resource within a second time period in a preconfigured uplink resource, a request to deactivate a start time unit of a preconfigured uplink resource, a request to deactivate an end time unit of a preconfigured uplink resource, a request to deactivate a time unit length of a preconfigured uplink resource, a request to activate a start time unit of a preconfigured uplink resource, a request to activate an end time unit of a preconfigured uplink resource, a request to activate a time unit length of a preconfigured uplink resource, a cell ID associated with a preconfigured uplink resource, or an uplink service type of the terminal device;
a request to deactivate a preconfigured downlink resource, a request to activate a preconfigured downlink resource, a request to deactivate a resource within a first time period in a preconfigured downlink resource, a request to activate a resource within a second time period in a preconfigured downlink resource, a request to deactivate a start time unit of a preconfigured downlink resource, a request to deactivate an end time unit of a preconfigured downlink resource, a request to deactivate a time unit length of a preconfigured downlink resource, a request to activate a start time unit of a preconfigured downlink resource, a request to activate an end time unit of a preconfigured downlink resource, a request to activate a time unit length of a preconfigured downlink resource, a cell ID associated with a preconfigured downlink resource, or a downlink service type of the terminal device; or
a discontinuous transmission DTX pattern of the terminal device, a discontinuous reception DRX pattern of the terminal device, a transmission parameter associated with the DTX pattern, a transmission parameter associated with the DRX pattern, an uplink transmission parameter of the terminal device, a downlink transmission parameter of the terminal device, an antenna configuration of the terminal device, a power parameter of the terminal device, or a power consumption mode of the terminal device.

In some embodiments, the uplink transmission parameter includes at least one of the following: a maximum quantity of uplink transmission layers, an uplink beam direction, an uplink minimum modulation and coding scheme MCS, an uplink maximum MCS, an uplink average MCS, an uplink beam indication, or a spatial domain transmission filter indication; and/or
the downlink transmission parameter includes at least one of the following: a maximum quantity of downlink transmission layers, a downlink beam direction, a downlink minimum MCS, a downlink maximum MCS, a downlink average MCS, a downlink beam indication, or a spatial domain receive filter indication.

In some embodiments, the first uplink resource is a resource in a first uplink cell, and the preconfigured uplink resource includes a resource in the first uplink cell and/or a second uplink cell.

In some embodiments, the determining unit 1001 is further configured to determine behavior of the terminal device based on the first information, where the behavior of the terminal device includes at least one of the following cases:
in a case that the first information is used to indicate a request to deactivate a preconfigured uplink resource, determining, by the terminal device, that a resource starting from the N^{th} resource in the preconfigured uplink resource is an invalid preconfigured uplink resource, where N is an integer greater than or equal to 1;
in a case that the first information is used to indicate a request to activate a preconfigured uplink resource, determining, by the terminal device, that a resource starting from the M^{th} resource in the preconfigured uplink resource is a valid preconfigured uplink resource, where M is an integer greater than or equal to 1;
in a case that the first information is used to indicate a request to deactivate a preconfigured downlink resource, determining, by the terminal device, that a resource starting from the N^{th} resource in the preconfigured downlink resource is an invalid preconfigured downlink resource, where N is an integer greater than or equal to 1; or
in a case that the first information is used to indicate a request to activate a preconfigured downlink resource, determining, by the terminal device, that a resource starting from the M^{th} resource in the preconfigured downlink resource is a valid preconfigured downlink resource, where M is an integer greater than or equal to 1.

In some embodiments, the determining unit 1001 is further configured to determine behavior of the terminal device based on the first information, where the behavior of the terminal device includes at least one of the following cases:
in a case that the first information is used to indicate a request to deactivate a resource within a first time period in a preconfigured uplink resource, determining, by the terminal device, that a resource within the first time period starting from the N^{th} resource in the preconfigured uplink resource is an invalid preconfigured uplink resource, where N is an integer greater than or equal to 1;
in a case that the first information is used to indicate a request to activate a resource within a second time period in a preconfigured uplink resource, determining, by the terminal device, that a resource within the second time period starting from the M^{th} resource in the preconfigured uplink resource is a valid preconfigured uplink resource, where M is an integer greater than or equal to 1;
in a case that the first information is used to indicate a request to deactivate a resource within a first time period in a preconfigured downlink resource, determining, by the terminal device, that a resource within the first time period starting from the N^{th} resource in the preconfigured downlink resource is an invalid preconfigured downlink resource, where N is an integer greater than or equal to 1; or
in a case that the first information is used to indicate a request to activate a resource within a second time period in a preconfigured downlink resource, determining, by the terminal device, that a resource within the second time period starting from the M^{th} resource in the preconfigured downlink resource is a valid preconfigured downlink resource, where M is an integer greater than or equal to 1.

In some embodiments, the transmission unit 1002 is further configured to receive second information, where the second information is feedback information of the first information; or the second information is used to determine the behavior of the terminal device; or the second information is determined by a network device based on the first information.

In some embodiments, the N^{th} resource is the 1st resource following the first uplink resource, or the N^{th} resource is the 1st resource after a first time interval following the first uplink resource; and/or
the M^{th} resource is the 1st resource following the first uplink resource, or the M^{th} resource is the 1st resource after a second time interval following the first uplink resource.

In some embodiments, the first time interval and the second time interval are a same time interval; and/or
the first time interval and the second time interval are determined based on same configuration information; and/or
the first time interval is predefined, or is configured by a network device; and/or
the first time interval is associated with a subcarrier spacing; and/or
the second time interval is predefined, or is configured by a network device; and/or
the second time interval is associated with a subcarrier spacing.

In some embodiments, the preconfigured uplink resource is determined based on first configuration information, and/or the preconfigured downlink resource is determined based on the first configuration information.

In some embodiments, the first configuration information is carried in at least one of the following: system information, a radio resource control RRC message, a media access control control element MAC CE, or downlink control information DCI.

In some embodiments, the preconfigured uplink resource includes at least one of the following: a PUCCH resource, a configured grant-physical uplink shared channel CG-PUSCH resource, a physical random access channel PRACH resource, or a sounding reference signal SRS resource.

In some embodiments, the preconfigured downlink resource includes at least one of the following: a PDCCH resource, a semi-persistent scheduling-physical downlink shared channel SPS-PDSCH resource, a synchronization signal block SSB resource, or a channel state information-reference signal CSI-RS resource.

In some embodiments, the transmission unit 1002 is further configured to receive second configuration information, where the second configuration information is used to indicate at least one of the following: configuring the terminal device to report the first information, configuring the first uplink resource, triggering the terminal device to report the first information, or reporting or skipping reporting the first information by the terminal device.

In some embodiments, the second configuration information is carried in at least one of the following: system information, an RRC message, a MAC CE, DCI, or a wake-up signal WUS.

In some embodiments, the transmission unit 1002 is further configured to send third information, where the third information is used to indicate that the terminal device has a capability of sending the first information; or the third information is used to indicate that the terminal device supports a user equipment UE capability of reporting the first information.

In some embodiments, the first uplink resource is a first physical uplink control channel PUCCH resource, and the first information is carried in a first PUCCH transmitted by using the first PUCCH resource.

In some embodiments, the first PUCCH resource is at least one of the following cases:
a quantity of bits carried by a PUCCH format corresponding to the first PUCCH resource is 1 or 2;
a quantity of bits carried by a PUCCH format corresponding to the first PUCCH resource is greater than 2;
the first PUCCH resource is used to transmit a scheduling request SR;
the first PUCCH resource is used to transmit a hybrid automatic repeat request-acknowledgment HARQ-ACK; or
the first PUCCH resource is used to transmit channel state information CSI.

In some embodiments, when the first PUCCH resource is used to transmit a HARQ-ACK, the HARQ-ACK and the first information are jointly encoded, or the HARQ-ACK and the first information are separately encoded; and/or
when the first PUCCH resource is used to transmit CSI, the CSI and the first information are jointly encoded, or the CSI and the first information are separately encoded.

In some embodiments, when the first PUCCH resource is used to transmit an SR, the first information is used to indicate a request to deactivate a resource within a first time period in a preconfigured uplink resource and/or a request to deactivate a resource within a first time period in a preconfigured downlink resource, where the first PUCCH resource has an association relationship with the first time period.

In some embodiments, the transmission unit 1002 is further configured to:
when it is determined that there is an SR requirement and the first information is not to be reported, transmit the first sequence by using the first PUCCH resource; or
when it is determined that there is no SR requirement and the first information is to be reported, transmit the second sequence by using the first PUCCH resource; or
when it is determined that there is no SR requirement and the first information is not to be reported, skip performing transmission on the first uplink resource.

In some embodiments, when the first PUCCH resource is used to transmit an SR, the first information is used to indicate a request to activate a resource within a second time period in a preconfigured uplink resource and/or a request to activate a resource within a second time period in a preconfigured downlink resource, where the first PUCCH resource has an association relationship with the second time period.

In some embodiments, the transmission unit 1002 is further configured to:
when it is determined that there is an SR requirement and the first information is to be reported, transmit the first sequence by using the first PUCCH resource; or
when it is determined that there is no SR requirement and the first information is to be reported, transmit the second sequence by using the first PUCCH resource; or
when it is determined that there is no SR requirement and the first information is not to be reported, skip performing transmission on the first uplink resource.

In some embodiments, the first PUCCH resource is associated with a first sequence and a second sequence, and the transmission unit 1002 is further configured to:
when it is determined that there is an SR requirement, transmit the first sequence by using the first PUCCH resource; or
when it is determined that there is no SR requirement and the first information is to be reported, transmit the second sequence by using the first PUCCH resource; or
when it is determined that there is no SR requirement and the first information is not to be reported, skip performing transmission on the first uplink resource.

In some embodiments, the first PUCCH resource is associated with a first sequence and a second sequence, and the transmission unit 1002 is further configured to:
when the terminal device determines that the first information is to be reported, transmit, by the terminal device, the first sequence by using the first PUCCH resource; or
when the terminal device determines that the first information is not to be reported and there is an SR requirement, transmit, by the terminal device, the second sequence by using the first PUCCH resource; or
when the terminal device determines that the first information is not to be reported and there is no SR requirement, skip, by the terminal device, performing transmission on the first uplink resource.

In some embodiments, a length of the first time period is the same as a length of the second time period; and/or
the first time period and the second time period are determined based on same configuration information; and/or
the first time period is predefined, or is configured by a network device; and/or
the first time period is determined based on a first time period set, the first time period set is predefined, or is configured by a network device, and the first time period set includes information about a plurality of time periods; and/or
the second time period is predefined, or is configured by a network device; and/or
the second time period is determined based on a second time period set, the second time period set is predefined, or is configured by a network device, and the second time period set includes information about a plurality of time periods.

FIG. 11 is a schematic diagram of a structural composition of another communications apparatus according to an embodiment of this application, which is applied to a network device. As shown in FIG. 11, the communications apparatus 1100 includes:
a determining unit 1101, configured to determine a first uplink resource, where the first uplink resource is used to transmit first information; and
a detection unit 1102, configured to detect the first information on the first uplink resource.

In some embodiments, the first information is used to indicate at least one of the following:
a request to deactivate a preconfigured uplink resource, a request to activate a preconfigured uplink resource, a request to deactivate a resource within a first time period in a preconfigured uplink resource, a request to activate a resource within a second time period in a preconfigured uplink resource, a request to deactivate a start time unit of a preconfigured uplink resource, a request to deactivate an end time unit of a preconfigured uplink resource, a request to deactivate a time unit length of a preconfigured uplink resource, a request to activate a start time unit of a preconfigured uplink resource, a request to activate an end time unit of a preconfigured uplink resource, a request to activate a time unit length of a preconfigured uplink resource, a cell ID associated with a preconfigured uplink resource, or an uplink service type of a terminal device;
a request to deactivate a preconfigured downlink resource, a request to activate a preconfigured downlink resource, a request to deactivate a resource within a first time period in a preconfigured downlink resource, a request to activate a resource within a second time period in a preconfigured downlink resource, a request to deactivate a start time unit of a preconfigured downlink resource, a request to deactivate an end time unit of a preconfigured downlink resource, a request to deactivate a time unit length of a preconfigured downlink resource, a request to activate a start time unit of a preconfigured downlink resource, a request to activate an end time unit of a preconfigured downlink resource, a request to activate a time unit length of a preconfigured downlink resource, a cell ID associated with a preconfigured downlink resource, or a downlink service type of the terminal device; or
a discontinuous transmission DTX pattern of the terminal device, a discontinuous reception DRX pattern of the terminal device, a transmission parameter associated with the DTX pattern, a transmission parameter associated with the DRX pattern, an uplink transmission parameter of the terminal device, a downlink transmission parameter of the terminal device, an antenna configuration of the terminal device, a power parameter of the terminal device, or a power consumption mode of the terminal device.

In some embodiments, the uplink transmission parameter includes at least one of the following: a maximum quantity of uplink transmission layers, an uplink beam direction, an uplink minimum modulation and coding scheme MCS, an uplink maximum MCS, an uplink average MCS, an uplink beam indication, or a spatial domain transmission filter indication; and/or
the downlink transmission parameter includes at least one of the following: a maximum quantity of downlink transmission layers, a downlink beam direction, a downlink minimum MCS, a downlink maximum MCS, a downlink average MCS, a downlink beam indication, or a spatial domain receive filter indication.

In some embodiments, the first uplink resource is a resource in a first uplink cell, and the preconfigured uplink resource includes a resource in the first uplink cell and/or a second uplink cell.

In some embodiments, the determining unit 1101 is further configured to determine behavior of the network device based on the first information, where the behavior of the network device includes at least one of the following cases:
in a case that the first information is used to indicate a request to deactivate a preconfigured uplink resource, determining, by the network device, that a resource starting from the N^{th} resource in the preconfigured uplink resource is an invalid preconfigured uplink resource, where N is an integer greater than or equal to 1;
in a case that the first information is used to indicate a request to activate a preconfigured uplink resource, determining, by the network device, that a resource starting from the M^{th} resource in the preconfigured uplink resource is a valid preconfigured uplink resource, where M is an integer greater than or equal to 1;
in a case that the first information is used to indicate a request to deactivate a preconfigured downlink resource, determining, by the network device, that a resource starting from the N^{th} resource in the preconfigured downlink resource is an invalid preconfigured downlink resource, where N is an integer greater than or equal to 1; or
in a case that the first information is used to indicate a request to activate a preconfigured downlink resource, determining, by the network device, that a resource starting from the M^{th} resource in the preconfigured downlink resource is a valid preconfigured downlink resource, where M is an integer greater than or equal to 1.

In some embodiments, the determining unit 1101 is further configured to determine behavior of the network device based on the first information, where the behavior of the network device includes at least one of the following cases:
in a case that the first information is used to indicate a request to deactivate a resource within a first time period in a preconfigured uplink resource, determining, by the network device, that a resource within the first time period starting from the N^{th} resource in the preconfigured uplink resource is an invalid preconfigured uplink resource, where N is an integer greater than or equal to 1;
in a case that the first information is used to indicate a request to activate a resource within a second time period in a preconfigured uplink resource, determining, by the network device, that a resource within the second time period starting from the M^{th} resource in the preconfigured uplink resource is a valid preconfigured uplink resource, where M is an integer greater than or equal to 1;
in a case that the first information is used to indicate a request to deactivate a resource within a first time period in a preconfigured downlink resource, determining, by the network device, that a resource within the first time period starting from the N^{th} resource in the preconfigured downlink resource is an invalid preconfigured downlink resource, where N is an integer greater than or equal to 1; or
in a case that the first information is used to indicate a request to activate a resource within a second time period in a preconfigured downlink resource, determining, by the network device, that a resource within the second time period starting from the M^{th} resource in the preconfigured downlink resource is a valid preconfigured downlink resource, where M is an integer greater than or equal to 1.

In some embodiments, the communications apparatus 1100 further includes a transmission unit 1103, configured to send second information, where the second information is feedback information of the first information; or the second information is used to determine behavior of the terminal device; or the second information is determined by the network device based on the first information.

In some embodiments, the N^{th} resource is the 1st resource following the first uplink resource, or the N^{th} resource is the 1st resource after a first time interval following the first uplink resource; and/or
the M^{th} resource is the 1st resource following the first uplink resource, or the M^{th} resource is the 1st resource after a second time interval following the first uplink resource.

In some embodiments, the first time interval and the second time interval are a same time interval; and/or
the first time interval and the second time interval are determined based on same configuration information; and/or
the first time interval is predefined, or is configured by a network device; and/or
the first time interval is associated with a subcarrier spacing; and/or
the second time interval is predefined, or is configured by a network device; and/or
the second time interval is associated with a subcarrier spacing.

In some embodiments, the preconfigured uplink resource is determined based on first configuration information, and/or the preconfigured downlink resource is determined based on the first configuration information.

In some embodiments, the first configuration information is carried in at least one of the following: system information, a radio resource control RRC message, a media access control control element MAC CE, or downlink control information DCI.

In some embodiments, the preconfigured uplink resource includes at least one of the following: a PUCCH resource, a configured grant-physical uplink shared channel CG-PUSCH resource, a physical random access channel PRACH resource, or a sounding reference signal SRS resource.

In some embodiments, the preconfigured downlink resource includes at least one of the following: a PDCCH resource, a semi-persistent scheduling-physical downlink shared channel SPS-PDSCH resource, a synchronization signal block SSB resource, or a channel state information-reference signal CSI-RS resource.

In some embodiments, the transmission unit 1103 is further configured to send second configuration information, where the second configuration information is used to indicate at least one of the following: configuring a terminal device to report the first information, configuring the first uplink resource, triggering the terminal device to report the first information, or reporting or skipping reporting the first information by the terminal device.

In some embodiments, the second configuration information is carried in at least one of the following: system information, an RRC message, a MAC CE, DCI, or a wake-up signal WUS.

In some embodiments, the transmission unit 1103 is further configured to receive third information, where the third information is used to indicate that a terminal device has a capability of sending the first information; or the third information is used to indicate that the terminal device supports a UE capability of reporting the first information.

In some embodiments, the first uplink resource is a first physical uplink control channel PUCCH resource, and the first information is carried in a first PUCCH transmitted by using the first PUCCH resource.

In some embodiments, the first PUCCH resource is at least one of the following cases:
a quantity of bits carried by a PUCCH format corresponding to the first PUCCH resource is 1 or 2;
a quantity of bits carried by a PUCCH format corresponding to the first PUCCH resource is greater than 2;
the first PUCCH resource is used to transmit a scheduling request SR;
the first PUCCH resource is used to transmit a hybrid automatic repeat request-acknowledgment HARQ-ACK; or
the first PUCCH resource is used to transmit channel state information CSI.

In some embodiments, when the first PUCCH resource is used to transmit a HARQ-ACK, the HARQ-ACK and the first information are jointly encoded, or the HARQ-ACK and the first information are separately encoded; and/or
when the first PUCCH resource is used to transmit CSI, the CSI and the first information are jointly encoded, or the CSI and the first information are separately encoded.

In some embodiments, when the first PUCCH resource is used to transmit an SR, the first information is used to indicate a request to deactivate a resource within a first time period in a preconfigured uplink resource and/or a request to deactivate a resource within a first time period in a preconfigured downlink resource, where the first PUCCH resource has an association relationship with the first time period.

In some embodiments, the first PUCCH resource is associated with a first sequence and a second sequence, and the transmission unit 1103 is further configured to:
when the network device detects the first sequence by using the first PUCCH resource, determine that a terminal device has an SR requirement and does not report the first information; or
when the network device detects the second sequence by using the first PUCCH resource, determine that a terminal device has no SR requirement and reports the first information; or
when the network device does not detect the first sequence or the second sequence by using the first PUCCH resource, determine that a terminal device has no SR requirement and does not report the first information.

In some embodiments, when the first PUCCH resource is used to transmit an SR, the first information is used to indicate a request to activate a resource within a second time period in a preconfigured uplink resource and/or a request to activate a resource within a second time period in a preconfigured downlink resource, where the first PUCCH resource has an association relationship with the second time period.

In some embodiments, the first PUCCH resource is associated with a first sequence and a second sequence, and the transmission unit 1103 is further configured to:
when the network device detects the first sequence by using the first PUCCH resource, determine that a terminal device has an SR requirement and reports the first information; or
when the network device detects the second sequence by using the first PUCCH resource, determine that a terminal device has no SR requirement and reports the first information; or
when the network device does not detect the first sequence or the second sequence by using the first PUCCH resource, determine that a terminal device has no SR requirement and does not report the first information.

In some embodiments, the first PUCCH resource is associated with a first sequence and a second sequence, and the transmission unit 1103 is further configured to:
when the network device detects the first sequence by using the first PUCCH resource, determine that a terminal device has an SR requirement; or
when the network device detects the second sequence by using the first PUCCH resource, determine that a terminal device has no SR requirement and reports the first information; or
when the network device does not detect the first sequence or the second sequence by using the first PUCCH resource, determine that a terminal device has no SR requirement and does not report the first information.

In some embodiments, the first PUCCH resource is associated with a first sequence and a second sequence, and the transmission unit 1103 is further configured to:
when the network device detects the first sequence by using the first PUCCH resource, determine that a terminal device reports the first information; or
when the network device detects the second sequence by using the first PUCCH resource, determine that a terminal device does not report the first information and has an SR requirement; or
when the network device does not detect the first sequence or the second sequence by using the first PUCCH resource, determine that a terminal device does not report the first information and has no SR requirement.

In some embodiments, a length of the first time period is the same as a length of the second time period; and/or
the first time period and the second time period are determined based on same configuration information; and/or
the first time period is predefined, or is configured by a network device; and/or
the first time period is determined based on a first time period set, the first time period set is predefined, or is configured by a network device, and the first time period set includes information about a plurality of time periods; and/or
the second time period is predefined, or is configured by a network device; and/or
the second time period is determined based on a second time period set, the second time period set is predefined, or is configured by a network device, and the second time period set includes information about a plurality of time periods.

A person skilled in the art should understand that related descriptions of the foregoing communications apparatus in embodiments of this application may be understood with reference to the related descriptions of the communication method in embodiments of this application.

FIG. 12 is a schematic structural diagram of a communications device according to an embodiment of this application. The communications device 1200 may include a terminal device or a network device. The communications device 1200 shown in FIG. 12 may include a processor 1210 and a memory 1220. The memory 1220 stores a computer program that can be run on the processor 1210, and the processor 1210 executes the program to implement the communication method in any one of the foregoing embodiments.

Optionally, the memory 1220 may be a separate component independent of the processor 1210, or may be integrated into the processor 1210.

In some embodiments, as shown in FIG. 12, the communications device 1200 may further include a transceiver 1230. The processor 1210 may control the transceiver 1230 to communicate with another device, and specifically, to send information or data to the another device, or to receive information or data sent by the another device.

The transceiver 1230 may include a transmitter and a receiver. The transceiver 1230 may further include an antenna, and there may be one or more antennas.

In some embodiments, the communications device 1200 may particularly be the network device in embodiments of this application, and the communications device 1200 may implement respective processes implemented by the network device in methods in embodiments of this application. For brevity, details are not described herein again.

In some embodiments, the communications device 1200 may particularly be the terminal device in embodiments of this application, and the communications device 1200 may implement respective processes implemented by the terminal device in methods in embodiments of this application. For brevity, details are not described herein again.

An embodiment of this application further provides a computer storage medium. The computer storage medium stores one or more programs, and the one or more programs may be executed by one or more processors to implement the communication method in any embodiment of this application.

In some embodiments, the computer-readable storage medium may be applied to the terminal device or the network device in embodiments of this application, and the computer program causes a computer to execute respective processes implemented by the terminal device or the network device in methods in embodiments of this application. For brevity, details are not described herein again.

FIG. 13 is a schematic structural diagram of a chip according to an embodiment of this application. The chip 1300 shown in FIG. 13 includes a processor 1310, and the processor 1310 is configured to invoke and run a computer program in a memory, to execute a method in embodiments of this application.

In some embodiments, as shown in FIG. 13, the chip 1300 may further include a memory 1320. The processor 1310 may invoke and run a computer program in the memory 1320, to implement a method in embodiments of this application.

The memory 1320 may be a separate component independent of the processor 1310, or may be integrated into the processor 1310.

In some embodiments, the chip 1300 may further include an input interface 1330. The processor 1310 may control the input interface 1330 to communicate with another device or chip, and specifically, to obtain information or data sent by the another device or chip.

In some embodiments, the chip 1300 may further include an output interface 1340. The processor 1310 may control the output interface 1340 to communicate with another device or chip, and specifically, to output information or data to the another device or chip.

In some embodiments, the chip may be applied to the network device in embodiments of this application, and the chip may implement respective processes implemented by the network device in methods in embodiments of this application. For brevity, details are not described herein again.

In some embodiments, the chip may be applied to the terminal device in embodiments of this application, and the chip may implement respective processes implemented by the terminal device in methods in embodiments of this application. For brevity, details are not described herein again.

It should be understood that the chip mentioned in this embodiment of this application may also be referred to as a system-level chip, a system chip, a chip system, or a system-on-chip.

An embodiment of this application further provides a computer program product. The computer program product includes a computer storage medium, the computer storage medium stores a computer program, the computer program includes instructions that can be executed by at least one processor, and the instructions, when executed by the at least one processor, implement the communication method in any embodiment of this application.

In some embodiments, the computer program product may be applied to the terminal device or the network device in embodiments of this application, and the computer program instructions cause a computer to execute respective processes implemented by the terminal device or the network device in methods in embodiments of this application. For brevity, details are not described herein again.

Optionally, the computer program product in this embodiment of this application may also be referred to as a software product in some other embodiments.

An embodiment of this application further provides a computer program. The computer program causes a computer to execute the communication method in any embodiment of this application.

In some embodiments, the computer program may be applied to the terminal device or the network device in embodiments of this application, and the computer program, when run by a computer, causes the computer to execute respective processes implemented by the terminal device or the network device in methods in embodiments of this application. For brevity, details are not described herein again.

The processor, the communications apparatus, or the chip in embodiments of this application may be an integrated circuit chip having a signal processing capability. In an implementation process, the steps in the foregoing method embodiments may be performed by using an integrated logic circuit of hardware of the processor or instructions in a software form. The foregoing processor, communications apparatus, or chip may include integration of any one or more of the following: a general-purpose processor, an application-specific integrated circuit (ASIC), a digital signal processor (DSP), a digital signal processing device (DSPD), a programmable logic device (PLD), a field programmable gate array (FPGA), a central processing unit (CPU), a graphics processing unit (GPU), an embedded neural-network processing unit (NPU), a controller, a microcontroller, a microprocessor, a programmable logic device, a discrete gate or a transistor logic device, or a discrete hardware component. The processor can implement or perform the methods, steps and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory or the computer storage medium in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct Rambus random access memory (DR RAM). It should be noted that, the memory in the systems and methods described in this specification includes but is not limited to these memories and any memory of another proper type.

It should be understood that, by way of example but not limitative description, for example, the memory or the computer storage medium in embodiments of this application may alternatively be a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), a direct rambus random access memory (DR RAM), or the like. In other words, the memory in this embodiment of this application includes but is not limited to these memories and any memory of another proper type.

A person of ordinary skill in the art may be aware that, units and algorithm steps in examples described in combination with embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

Those skilled in the art that may clearly understand that, for the purpose of convenient and brief description, for detailed working processes of the foregoing system, apparatus, and unit, reference may be made to a corresponding procedure in the foregoing method embodiments, and details are not described herein again.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

Units described as separate components may be or may not be physically separate, and components displayed as units may be or may not be physical units, that is, may be located in one place or distributed on a plurality of network units. Some or all of the units may be selected according to actual requirements to achieve the objective of the solutions of embodiments.

In addition, function units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions in embodiments of this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to execute all or some of the steps of the methods in embodiments of this application. The foregoing storage medium includes any medium that can store program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

1. A terminal device, comprising a processor and a memory, wherein the memory is configured to store a computer program, and the processor is configured to invoke and run the computer program stored in the memory to cause the terminal device to perform:
determining a first uplink resource, wherein the first uplink resource is used to transmit first information; and
transmitting the first information on the first uplink resource, or skipping transmitting the first information on the first uplink resource.

2. The terminal device according to claim 1, wherein the first information is used to indicate at least one of following:
a request to deactivate a preconfigured uplink resource, a request to activate a preconfigured uplink resource, a request to deactivate a resource within a first time period in a preconfigured uplink resource, a request to activate a resource within a second time period in a preconfigured uplink resource, a request to deactivate a start time unit of a preconfigured uplink resource, a request to deactivate an end time unit of a preconfigured uplink resource, a request to deactivate a time unit length of a preconfigured uplink resource, a request to activate a start time unit of a preconfigured uplink resource, a request to activate an end time unit of a preconfigured uplink resource, a request to activate a time unit length of a preconfigured uplink resource, a cell ID associated with a preconfigured uplink resource, or an uplink service type of the terminal device;
a request to deactivate a preconfigured downlink resource, a request to activate a preconfigured downlink resource, a request to deactivate a resource within a first time period in a preconfigured downlink resource, a request to activate a resource within a second time period in a preconfigured downlink resource, a request to deactivate a start time unit of a preconfigured downlink resource, a request to deactivate an end time unit of a preconfigured downlink resource, a request to deactivate a time unit length of a preconfigured downlink resource, a request to activate a start time unit of a preconfigured downlink resource, a request to activate an end time unit of a preconfigured downlink resource, a request to activate a time unit length of a preconfigured downlink resource, a cell ID associated with a preconfigured downlink resource, or a downlink service type of the terminal device; or
a discontinuous transmission (DTX) pattern of the terminal device, a discontinuous reception (DRX) pattern of the terminal device, a transmission parameter associated with the DTX pattern, a transmission parameter associated with the DRX pattern, an uplink transmission parameter of the terminal device, a downlink transmission parameter of the terminal device, an antenna configuration of the terminal device, a power parameter of the terminal device, or a power consumption mode of the terminal device.

3. The terminal device according to claim 2, wherein the uplink transmission parameter comprises at least one of following: a maximum quantity of uplink transmission layers, an uplink beam direction, an uplink minimum modulation and coding scheme (MCS), an uplink maximum MCS, an uplink average MCS, an uplink beam indication, or a spatial domain transmission filter indication; and/or
the downlink transmission parameter comprises at least one of following: a maximum quantity of downlink transmission layers, a downlink beam direction, a downlink minimum MCS, a downlink maximum MCS, a downlink average MCS, a downlink beam indication, or a spatial domain receive filter indication.

4. The terminal device according to claim 2, wherein the first uplink resource is a resource in a first uplink cell, and the preconfigured uplink resource comprises a resource in the first uplink cell and/or a second uplink cell.

5. The terminal device according to claim 2, wherein the processor is further configured to invoke and run the computer program stored in the memory to cause the terminal device to perform:
determining behavior of the terminal device based on the first information, wherein the behavior of the terminal device comprises at least one of following cases:
in a case that the first information is used to indicate a request to deactivate a preconfigured uplink resource, determining, by the terminal device, that a resource starting from the N^{th} resource in the preconfigured uplink resource is an invalid preconfigured uplink resource, wherein N is an integer greater than or equal to 1;
in a case that the first information is used to indicate a request to activate a preconfigured uplink resource, determining, by the terminal device, that a resource starting from the M^{th} resource in the preconfigured uplink resource is a valid preconfigured uplink resource, wherein M is an integer greater than or equal to 1;
in a case that the first information is used to indicate a request to deactivate a preconfigured downlink resource, determining, by the terminal device, that a resource starting from the N^{th} resource in the preconfigured downlink resource is an invalid preconfigured downlink resource, wherein N is an integer greater than or equal to 1; or
in a case that the first information is used to indicate a request to activate a preconfigured downlink resource, determining, by the terminal device, that a resource starting from the M^{th} resource in the preconfigured downlink resource is a valid preconfigured downlink resource, wherein M is an integer greater than or equal to 1.

6. The terminal device according to claim 2, wherein the processor is further configured to invoke and run the computer program stored in the memory to cause the terminal device to perform:
determining behavior of the terminal device based on the first information, wherein the behavior of the terminal device comprises at least one of following cases:
in a case that the first information is used to indicate a request to deactivate a resource within a first time period in a preconfigured uplink resource, determining, by the terminal device, that a resource within the first time period starting from the N^{th} resource in the preconfigured uplink resource is an invalid preconfigured uplink resource, wherein N is an integer greater than or equal to 1;
in a case that the first information is used to indicate a request to activate a resource within a second time period in a preconfigured uplink resource, determining, by the terminal device, that a resource within the second time period starting from the M^{th} resource in the preconfigured uplink resource is a valid preconfigured uplink resource, wherein M is an integer greater than or equal to 1;
in a case that the first information is used to indicate a request to deactivate a resource within a first time period in a preconfigured downlink resource, determining, by the terminal device, that a resource within the first time period starting from the N^{th} resource in the preconfigured downlink resource is an invalid preconfigured downlink resource, wherein N is an integer greater than or equal to 1; or
in a case that the first information is used to indicate a request to activate a resource within a second time period in a preconfigured downlink resource, determining, by the terminal device, that a resource within the second time period starting from the M^{th} resource in the preconfigured downlink resource is a valid preconfigured downlink resource, wherein M is an integer greater than or equal to 1.

7. The terminal device according to claim 5, wherein before the determining behavior of the terminal device based on the first information, the processor is further configured to invoke and run the computer program stored in the memory to cause the terminal device to perform:
receiving second information, wherein the second information is feedback information of the first information; or the second information is used to determine the behavior of the terminal device; or the second information is determined by a network device based on the first information.

8. The terminal device according to claim 1, wherein the processor is further configured to invoke and run the computer program stored in the memory to cause the terminal device to perform:
receiving second configuration information, wherein the second configuration information is used to indicate at least one of following: configuring the terminal device to report the first information, configuring the first uplink resource, triggering the terminal device to report the first information, or reporting or skipping reporting the first information by the terminal device.

9. The terminal device according to claim 1, wherein the processor is further configured to invoke and run the computer program stored in the memory to cause the terminal device to perform:
sending third information, wherein the third information is used to indicate that the terminal device has a capability of sending the first information; or the third information is used to indicate that the terminal device supports a user equipment (UE) capability of reporting the first information.

10. The terminal device according to claim 1, wherein the first uplink resource is a first physical uplink control channel (PUCCH) resource, and the first information is carried in a first PUCCH transmitted by using the first PUCCH resource.

11. A network device, comprising a processor and a memory, wherein the memory is configured to store a computer program, and the processor is configured to invoke and run the computer program stored in the memory to cause the network device to perform:
determining a first uplink resource, wherein the first uplink resource is used to transmit first information; and
detecting the first information on the first uplink resource.

12. The network device according to claim 11, wherein the first information is used to indicate at least one of following:
a request to deactivate a preconfigured uplink resource, a request to activate a preconfigured uplink resource, a request to deactivate a resource within a first time period in a preconfigured uplink resource, a request to activate a resource within a second time period in a preconfigured uplink resource, a request to deactivate a start time unit of a preconfigured uplink resource, a request to deactivate an end time unit of a preconfigured uplink resource, a request to deactivate a time unit length of a preconfigured uplink resource, a request to activate a start time unit of a preconfigured uplink resource, a request to activate an end time unit of a preconfigured uplink resource, a request to activate a time unit length of a preconfigured uplink resource, a cell ID associated with a preconfigured uplink resource, or an uplink service type of a terminal device;
a request to deactivate a preconfigured downlink resource, a request to activate a preconfigured downlink resource, a request to deactivate a resource within a first time period in a preconfigured downlink resource, a request to activate a resource within a second time period in a preconfigured downlink resource, a request to deactivate a start time unit of a preconfigured downlink resource, a request to deactivate an end time unit of a preconfigured downlink resource, a request to deactivate a time unit length of a preconfigured downlink resource, a request to activate a start time unit of a preconfigured downlink resource, a request to activate an end time unit of a preconfigured downlink resource, a request to activate a time unit length of a preconfigured downlink resource, a cell ID associated with a preconfigured downlink resource, or a downlink service type of the terminal device; or
a discontinuous transmission (DTX) pattern of the terminal device, a discontinuous reception (DRX) pattern of the terminal device, a transmission parameter associated with the DTX pattern, a transmission parameter associated with the DRX pattern, an uplink transmission parameter of the terminal device, a downlink transmission parameter of the terminal device, an antenna configuration of the terminal device, a power parameter of the terminal device, or a power consumption mode of the terminal device.

13. The network device according to claim 12, wherein the uplink transmission parameter comprises at least one of following: a maximum quantity of uplink transmission layers, an uplink beam direction, an uplink minimum modulation and coding scheme (MCS), an uplink maximum MCS, an uplink average MCS, an uplink beam indication, or a spatial domain transmission filter indication; and/or
the downlink transmission parameter comprises at least one of following: a maximum quantity of downlink transmission layers, a downlink beam direction, a downlink minimum MCS, a downlink maximum MCS, a downlink average MCS, a downlink beam indication, or a spatial domain receive filter indication.

14. The network device according to claim 12, wherein the first uplink resource is a resource in a first uplink cell, and the preconfigured uplink resource comprises a resource in the first uplink cell and/or a second uplink cell.

15. The network device according to claim 12, wherein the processor is further configured to invoke and run the computer program stored in the memory to cause the network device to perform:
determining behavior of the network device based on the first information, wherein the behavior of the network device comprises at least one of following cases:
in a case that the first information is used to indicate a request to deactivate a preconfigured uplink resource, determining, by the network device, that a resource starting from the N^{th} resource in the preconfigured uplink resource is an invalid preconfigured uplink resource, wherein N is an integer greater than or equal to 1;
in a case that the first information is used to indicate a request to activate a preconfigured uplink resource, determining, by the network device, that a resource starting from the M^{th} resource in the preconfigured uplink resource is a valid preconfigured uplink resource, wherein M is an integer greater than or equal to 1;
in a case that the first information is used to indicate a request to deactivate a preconfigured downlink resource, determining, by the network device, that a resource starting from the N^{th} resource in the preconfigured downlink resource is an invalid preconfigured downlink resource, wherein N is an integer greater than or equal to 1; or
in a case that the first information is used to indicate a request to activate a preconfigured downlink resource, determining, by the network device, that a resource starting from the M^{th} resource in the preconfigured downlink resource is a valid preconfigured downlink resource, wherein M is an integer greater than or equal to 1.

16. The network device according to claim 12, wherein the processor is further configured to invoke and run the computer program stored in the memory to cause the network device to perform:
determining behavior of the network device based on the first information, wherein the behavior of the network device comprises at least one of following cases:
in a case that the first information is used to indicate a request to deactivate a resource within a first time period in a preconfigured uplink resource, determining, by the network device, that a resource within the first time period starting from the N^{th} resource in the preconfigured uplink resource is an invalid preconfigured uplink resource, wherein N is an integer greater than or equal to 1;
in a case that the first information is used to indicate a request to activate a resource within a second time period in a preconfigured uplink resource, determining, by the network device, that a resource within the second time period starting from the M^{th} resource in the preconfigured uplink resource is a valid preconfigured uplink resource, wherein M is an integer greater than or equal to 1;
in a case that the first information is used to indicate a request to deactivate a resource within a first time period in a preconfigured downlink resource, determining, by the network device, that a resource within the first time period starting from the N^{th} resource in the preconfigured downlink resource is an invalid preconfigured downlink resource, wherein N is an integer greater than or equal to 1; or
in a case that the first information is used to indicate a request to activate a resource within a second time period in a preconfigured downlink resource, determining, by the network device, that a resource within the second time period starting from the M^{th} resource in the preconfigured downlink resource is a valid preconfigured downlink resource, wherein M is an integer greater than or equal to 1.

17. The network device according to claim 15, wherein before the determining behavior of the network device based on the first information, the processor is further configured to invoke and run the computer program stored in the memory to cause the network device to perform:
sending second information, wherein the second information is feedback information of the first information; or the second information is used to determine behavior of the terminal device; or the second information is determined by the network device based on the first information.

18. The network device according to claim 11, wherein the processor is further configured to invoke and run the computer program stored in the memory to cause the network device to perform:
sending second configuration information, wherein the second configuration information is used to indicate at least one of following: configuring a terminal device to report the first information, configuring the first uplink resource, triggering the terminal device to report the first information, or reporting or skipping reporting the first information by the terminal device.

19. The network device according to claim 11, wherein the processor is further configured to invoke and run the computer program stored in the memory to cause the network device to perform:
receiving third information, wherein the third information is used to indicate that a terminal device has a capability of sending the first information; or the third information is used to indicate that the terminal device supports a user equipment (UE) capability of reporting the first information.

20. A communication method, the method comprising:
determining, by a terminal device, a first uplink resource, wherein the first uplink resource is used to transmit first information; and
transmitting, by the terminal device, the first information on the first uplink resource, or skipping, by the terminal device, transmitting the first information on the first uplink resource.
